(19) United States
(12) Patent Application Publication
(10) Pub. No.: US 2018/0077440 A1
(43) Pub. Date: Mar. 15, 2018

(54) SYSTEM AND METHOD OF CREATING, ANALYZING, AND CATEGORIZING MEDIA

(71) Applicant: Cayke, Inc., San Diego, CA (US)

(72) Inventors: Karan Wadhera, Fremont, CA (US); Shuai Zhu, Fremont, CA (US)

(21) Appl. No.: 15/699,920

(22) Filed: Sep. 8, 2017

Related U.S. Application Data
(60) Provisional application No. 62/385,398, filed on Sep. 9, 2016.

(51) Int. Cl. H04N 21/262; H04N 21/482; H04N 21/4788; H04N 21/845; H04N 21/8547; H04N 21/435

(52) U.S. Cl. CPC H04N 21/26283; H04N 21/482; H04N 21/4788; H04N 21/2187; H04N 21/8547; H04N 21/435; H04N 21/8456

(57) ABSTRACT

In one aspect, a method of managing online media is disclosed. The method comprises receiving a media file from a media source, the media file representative of an event and receiving a user input indicating an occurrence to be identified in the media file. The method also comprises obtaining data related to the media file from one or more sources, wherein the data comprises information describing the media file or a portion thereof and wherein the data is based on the user input and generating a media timeline associated with the media file. The method further comprises identifying the occurrence in the media file and a timestamp for the identified occurrence based on the data, the timestamp identifying a time corresponding to a data timeline of the data and generating an output comprising the occurrence and the timestamp in relation to the timeline.

### CROSS-REFERENCE TO RELATED APPLICATIONS

This application claims priority under 35 U.S.C. § 119(e) to U.S. Provisional Patent Application No. 62/385,398 filed on Sep. 9, 2016. This application is incorporated herein by reference in its entirety. Furthermore, any and all priority claims identified in the Application Data Sheet, or any correction thereto, are hereby incorporated herein by reference in their entireties under 37 C.F.R. § 1.57.

This application relates to handling media generated for online (e.g., via the Internet or other network connection) consumption. The media may include recorded or livestreaming video and/or audio from an event. The media may have associated with it various data, including data from online sources (e.g., comments from social media sources), data from announcer commentary, data from the media capture device, and data from analysis of the media itself. The media may include various scenes or portions of interest to one or more users. For example, a recorded or livestreamed competition may be later analyzed by one or more competitors involved in the competition. However, reviewing the entire recorded or livestreamed competition may require a large amount of time, especially when the recorded or livestreamed competition is of extended duration or involves many competitors. Additionally, the reviewing competitor may only be interested in particular aspects of the competition, for example, events involving the reviewing competitor. Accordingly, the reviewing competitor may desire a system or method for analyzing and parsing the recorded or livestreamed competition based on particular inputs as provided by the reviewing competitor. Additionally, users may desire that such analyzing and parsing be performed dynamically as the recorded event or livestreamed event occurs, thus making the parsed content available immediately for consumption (e.g., viewing, etc.) as it occurs. Thus, systems and methods of generating highlights, summaries, or excerpts of media from live or prerecorded media content based on analysis of the live or prerecorded media content and external data are desired.

### BACKGROUND

This application relates to handling media generated for online (e.g., via the Internet or other network connection) consumption. The media may include recorded or livestreaming video and/or audio from an event. The media may have associated with it various data, including data from online sources (e.g., comments from social media sources), data from announcer commentary, data from the media capture device, and data from analysis of the media itself. The media may include various scenes or portions of interest to one or more users. For example, a recorded or livestreamed competition may be later analyzed by one or more competitors involved in the competition. However, reviewing the entire recorded or livestreamed competition may require a large amount of time, especially when the recorded or livestreamed competition is of extended duration or involves many competitors. Additionally, the reviewing competitor may only be interested in particular aspects of the competition, for example, events involving the reviewing competitor. Accordingly, the reviewing competitor may desire a system or method for analyzing and parsing the recorded or livestreamed competition based on particular inputs as provided by the reviewing competitor. Additionally, users may desire that such analyzing and parsing be performed dynamically as the recorded event or livestreamed event occurs, thus making the parsed content available immediately for consumption (e.g., viewing, etc.) as it occurs. Thus, systems and methods of generating highlights, summaries, or excerpts of media from live or prerecorded media content based on analysis of the live or prerecorded media content and external data are desired.

### SUMMARY OF CERTAIN INVENTIVE ASPECTS

Various implementations of methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described herein comprises a method of managing online media. The method comprises receiving a media file from a media source, the media file representative of an event and receiving a user input indicating an occurrence or a type of occurrence to be identified in the media file. The method also comprises obtaining data related to the media file from one or more sources, wherein the data comprises information describing or commenting on the media file or a portion thereof and wherein the data is based on the user input and generating a media timeline associated with the media file. The method further comprises identifying the occurrence in the media file and a timestamp for the identified occurrence based on the data, the timestamp identifying a time corresponding to a data timeline of the data and generating an output comprising the occurrence and the timestamp in relation to the timeline.

Another aspect of the subject matter described herein comprises a system for managing online media. The system comprises means for receiving a media file from a media source, the media file representative of an event and means for receiving a user input indicating an occurrence or a type of occurrence to be identified in the media file. The system also comprises means for obtaining data related to the media file from one or more sources, wherein the data comprises information describing or commenting on the media file or a portion thereof and wherein the data is based on the user input and means for generating a media timeline associated with the media file. The system further comprises means for identifying the occurrence in the media file and a timestamp for the identified occurrence based on the data, the timestamp identifying a time corresponding to a data timeline of the data and means for generating an output comprising the occurrence and the timestamp in relation to the timeline.

An additional aspect of the subject matter described herein comprises another system for managing online media. The system comprises a memory and a processor. The memory is configured to receive a media file from a media source, the media file representative of an event. The memory is also configured to receive a user input indicating an occurrence or a type of occurrence to be identified in the media file and obtain data related to the media file from one or more sources, wherein the data comprises information describing or commenting on the media file or a portion thereof and wherein the data is based on the user input. The processor is configured to generate a media timeline associated with the media file. The processor is also configured to identify the occurrence in the media file and a timestamp for the identified occurrence based on the data, the timestamp identifying a time corresponding to a data timeline of the data and generate an output comprising the occurrence and the timestamp in relation to the timeline.

Another aspect of the subject matter described herein comprises a non-transitory, computer readable medium encoded with instructions for directing a processor to perform a method of managing online media. The method comprises receiving a media file from a media source, the media file representative of an event and receiving a user input indicating an occurrence or a type of occurrence to be identified in the media file. The method also comprises obtaining data related to the media file from one or more sources, wherein the data comprises information describing or commenting on the media file or a portion thereof and wherein the data is based on the user input and generating a media timeline associated with the media file. The method further comprises identifying the occurrence in the media file and a timestamp for the identified occurrence based on the data, the timestamp identifying a time corresponding to a data timeline of the data and generating an output comprising the occurrence and the timestamp in relation to the timeline.

### BRIEF DESCRIPTION OF THE DRAWINGS

The above-mentioned aspects, as well as other features, aspects, and advantages of the present technology will now be described in connection with various aspects, with reference to the accompanying drawings. The illustrated aspects, however, are merely examples and are not intended to be limiting. Throughout the drawings, similar symbols typically identify similar components, unless context dictates otherwise. Note that the relative dimensions of the following figures may not be drawn to scale.

The figures depicted herein and the corresponding descriptions may utilize examples involving video games, esports events, and stick and ball sports, among others, and corresponding entities and items. However, these examples may be replaced with any event that may be livestreamed or recorded for later streaming or broadcast.

FIG. 1 illustrates one possible organization of a system that can provide streaming media from a source to users for consumption via a network, in accordance with an exemplary embodiment.

FIG. 2 is a block diagram corresponding to an aspect of a hardware and/or software component of an example embodiment of the system of FIG. 1.

FIG. 3 is an example of a flowchart for automatically analyzing and generating media based on an event, in accordance with an exemplary embodiment.

FIG. 4 is an example of a flowchart for generating a timeline for a derivative work based on one or more available media, in accordance with an exemplary embodiment.

FIG. 5 is an example of a flowchart for generating a derivative work based on a timeline and one or more available media, in accordance with an exemplary embodiment.

FIG. 6 depicts a diagram of a system and corresponding inputs/outputs for identifying, categorizing, and/or describing occurrences in a source media file of an event.

FIG. 7 depicts a flowchart for a method of obtaining data in a system as shown in block of FIG. 6, in accordance with an exemplary embodiment.

FIG. 8 depicts a diagram of a system and corresponding inputs, processes, and outputs for identifying, categorizing, and/or describing occurrences in a source media file of an event based on online discussion comments or posts, in accordance with an exemplary embodiment.

FIG. 9 depicts a diagram of a system and corresponding inputs, processes, and outputs for identifying, categorizing, and/or describing occurrences in a source media file of an event based on media clip posts, in accordance with an exemplary embodiment.

FIG. 10 depicts a diagram of a system and corresponding inputs, processes, and outputs for identifying, categorizing, and/or describing occurrences in a source media file of an event based on spectator or reaction media, in accordance with an exemplary embodiment.

FIG. 11 depicts a diagram of a system and corresponding inputs, processes, and outputs for identifying, categorizing, and/or describing occurrences in a source media file of an event based on data received from the source itself, in accordance with an exemplary embodiment.

FIG. 12 depicts a diagram of a system and corresponding inputs, processes, and outputs for identifying, categorizing, and/or describing occurrences in a source media file of an event based on the source media file and related media files, in accordance with an exemplary embodiment.

FIG. 13 is a diagram for creating a derivative work (e.g., highlight or sequence of clips) based on a plurality of input clips or media files as analyzed according to one of FIGS. 8-12, in accordance with an exemplary embodiment.

### DETAILED DESCRIPTION

Various aspects of the novel systems, apparatuses, and methods are described more fully hereinafter with reference to the accompanying drawings. The teachings disclosed may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different consumer goods and services industries. The detailed description and drawings are merely illustrative of the disclosure rather than limiting, the scope of the disclosure being defined by the appended claims and equivalents thereof.

Popular network technologies may include various types of wireless or wired networks. The wireless or wired network may be used to interconnect nearby devices together, employing widely used networking protocols. The various aspects described herein may apply to any communication standard, such as a wireless 802.11 protocol.

The descriptions included herein may utilize examples involving video games, esports events, and stick and ball sports, among others. However, these examples may be replaced with any event that may be livestreamed or recorded for later streaming or broadcast. Accordingly, the systems and methods described herein may be used in gaming, esports events, stick and ball sports, comedy events, liveblog events, movies, news casts, concerts, contests, symposiums, presentations, conferences, and similar events.

Various entities are currently producing media content for consumption by online consumers. In some embodiments, the media content may include livestreaming audio or video or previously recorded audio or video. In some cases, these or other entities or the consumers may wish to manipulate the original media content. For example, such manipulation may involve combining one or more portions of the media content with additional media (e.g., other video, audio, pictures, text, gifs, etc.) to generate a derivative work. In other examples, the entities or consumers may wish to extract information from some or all of the media content. Accordingly, one or more portions of the original media content may be captured and manipulated to adjust timing, length, effects, volume, filters, etc., may be analyzed, and/or may be stored for further use. When portions of multiple original media content are combined into a single derivative work, the individual portions may be used together in a linear or time-centric fashion.

Currently, manipulation of original media content may be resource intensive, requiring large amounts of storage space, time, and processing power. Storage space is needed to store the original media content or the manipulated portions of the original media content. Processing power is needed to generate the desired portions of the original media content and apply any desired manipulations to the portions prior to saving in the storage space. For example, the portions may be stored locally or in a centralized manner to simplify the creation of the derivative work from the individual portions. In some embodiments, when the portions are sourced from multiple sources (e.g., multiple original media streams), the entire original media streams (or larger portions thereof than merely the desired portion) may be stored locally or centrally. Additionally, processing power may be used to generate a compilation from a plurality of portions of original media content. Such processing may be improved by adding processing hardware to reduce processing times.

Similarly, original media content may be analyzed based on external human input (e.g., comments, creation of video clips, etc.) and based on associated data (e.g., data of the original media itself, such as scores and/or statistics tracked in the original media content) to extract sentiment and perception of particular events or moments during the original media content. In some embodiments, the sentiments and perception may be used to automatically create derivative content or suggest media based on requests of a particular consumer. Accordingly, sentiments and perception may be used to identify events in original media content and may be used to generate media clips from the original media content. These media clips may be used to generate derivative works, with or without the sentiments and perception identified. Thus, the analysis described here may provide for simplified analysis of the original media content over current methods of video analysis and provide for simplified creation of derivative works.

However, creation of such derivative works based on portions (manipulated or not) of one or more original media streams may be improved without requiring additional hardware (e.g., storage and processing hardware). As described herein, systems and methods may provide for creation of derivative works based on original media streams using a fraction of processing power and time generally required. The systems and methods also provide for the creation of modular content that can lead to further manipulation, analysis, creation, and categorization of the original media streams and/or portions thereof

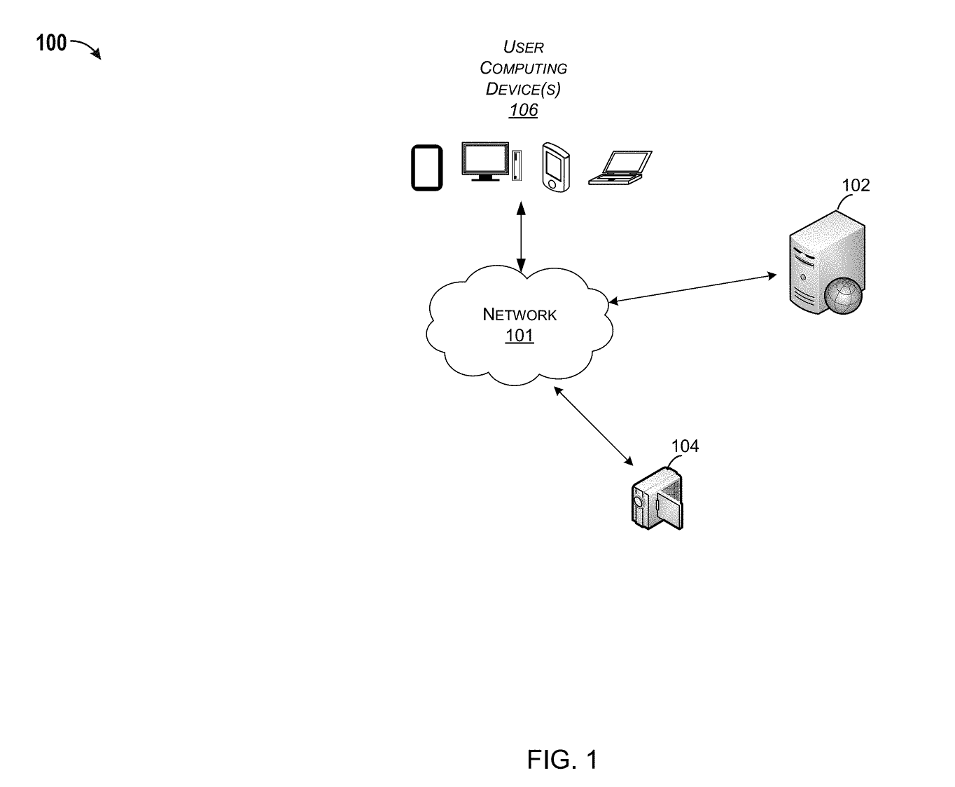

FIG. 1 illustrates one possible organization of a system 100 that can provide streaming media from a source to users for consumption via a network, in accordance with an exemplary embodiment. The system 100 comprises a terminal 102 (e.g., a terminal or server used for identifying and generating portions of original media streams), a media source 104, one or more computing devices 106 used by media consumers, and a network 101. Additionally, communication links are shown enabling communication among the components of system 100 via the network 101. In some embodiments, one or more of the devices (e.g., the terminal 102 or the user devices 106) described herein may be combined into a single server and/or terminal. In some embodiments, one or more of the devices (e.g., the terminal 102) may have functions that are divided among multiple other devices (not shown). In some embodiments, two or more of the components described above may be integrated. In some embodiments, one or more of the components may be excluded from the system 100. The system 100 may be used to implement systems and methods described herein.

In some embodiments, the network 101 may comprise any wired or wireless communication network by which data and/or information may be communicated between multiple electronic and/or computing devices. The terminal 102 may comprise any computing device configured to transmit and receive data and information via the network 101, for example media streams or requests for media streams or requests to analyze and/or manipulate media streams. In some embodiments, the terminal 102 may comprise or have access to various records and information associated with users and/or original media stream providers, such as a user database, inventory of media streams, etc. In some embodiments, the terminal 102 may provide access to software or other tools for manipulating media streams. In some embodiments, the terminal 102 may receive media streams after they are manipulated.

The media source 104 may comprise a database or any other storage system that stores media content (e.g., original and derivative). For example, the media source 104 may comprise a database of video files or audio files. In some embodiments, the media source 104 may comprise a streaming media source, for example a computer, a webcam, a camera connected to the network 101, or any other source of streaming media. Accordingly, the media source 104 may comprise a source of any live or previously recorded media. In some embodiments, the media source 104 may include a storage destination for portions (e.g., the manipulated or unmanipulated portions) of media content once they have been manipulated by the media consumers. In some embodiments, the media source 104 may communicate (e.g., transmit and receive) the media content (original and/or derivative) itself In some embodiments, the media source 104 may also communicate data associated with the media content (e.g., details regarding the media content, such as time, information, details regarding objects in the media content, etc.). In some embodiments, though the media source 104 is shown as a single component, the media source 104 may actually comprise multiple individual sources.

The one or more computing devices 106 may comprise any computing device configured to view and/or manipulate online media content via the network 101. In some embodiments, the computing device 106 may be configured to receive media content from the media source 104 and select and/or identify portions of the media content for use by the terminal 102. In some embodiments, the computing device 106 may communicate with the terminal 102 to indicate manipulations of the media content. In some embodiments, the computing device 106 may allow the media consumer to view and/or manipulate portions of the received media content. In some embodiments, the terminal 102 and the one or more computing devices 106 may be integrated into a single terminal or device.

In some embodiments, a media consumer may use the computing device 106 to identify one or more portions of the media content and build a derivative work based on the portions. The derivative work may comprise the portions from various media content with or without manipulations applied to one or more of the portions. For example, a derivative work may be based on a portion of a video from a media source 104 that is overlaid with audio from the same or another media source 104 at a particular time during the video. In such an example, portions of the corresponding media may be obtained from the media sources 104 and may be stored in a local memory or similar storage media of the computing device 106 or the terminal 102 with which the computing device 106 is interacting (e.g., RAM, HDD, SSD, flash memory, etc.). The media portions used in the derivative work may be associated with a common timeline. For example, the portion of the video may be obtained, stored in the storage media, and associated with a timeline corresponding to the derivative work. Similarly, the audio portion that is overlaid with the video file may be obtained, stored in the storage media, and associated with the timeline. These portions, and the associated timeline, may be stored in the computing device 106 or the terminal 102. The number of portions that are stored may depend on a number of portions used in the derivative work. In some embodiments, the portions that are used in the derivative work may not necessarily be stored locally but rather may be acquired from a remote or original location as needed for the derivative work.

As the portions are used in the derivative work, they may be replaced by other portions used in the derivative work. For example, as the active portions of the source media is no longer needed, preloaded portions of the next media sources are swapped in. Effects or manipulations, such as filters, speed modulation, pitch modulation, loops, volume adjustment, display size changes, movement, etc., may be applied to the media portions to build the derivative work that is presented to the end user.

The terminal 102 may provide data to the computing device 106. In some embodiments, the computing device 106 may pull (e.g., obtain) the media portions from the Internet and combine the media portions with associated information (e.g., the timeline). The media portions and the desired effects may be combined to serve the derivative work. The derivative work may follow the timeline according to which the media portion(s) are presented. The computing device 106 may thus transform the timeline and media portions into a consumable derivative media. In some embodiments, the video media of the example described above may be viewed as a base layer and all manipulations of the video media may be referred to as effects that are superimposed on top of the base layer.

In some additional and/or alternative embodiments, the methods and systems described herein may provide for automatic generation of highlight, summarization, and/or excerpt media clips from livestreaming or prerecorded media content and/or analysis thereof. The generation and analysis of the media clips may be based on parsing and analysis of information scraped (e.g., obtained) from various sources, including online sources such as live chat sessions, comments on the original media content, comments pulled from social media sites such as Facebook, Twitter, reddit, etc., external media clips, spectator reactions, data logs, and the media itself through analysis of various data incorporated into the media, such as scores, textual information, other data, etc., among others. The analysis of aggregation of these comments and scraped information may allow the systems and methods to extract sentiment and perception of certain points or periods in the media content in comparison with other portions of the media. These certain points or periods may be the bases for the generation of the media clips.

Accordingly, the terminal 102 or the computing device 106 may obtain a source media content from the media source 106. The terminal 102 or computing device 106 may then scrape external sites or analyze the source media content itself to identify information that may be used to build a data model of sentiment and perception of the source media content at different points of time and as a whole.

In some embodiments, the system for generating derivative works may be combined with the system for identifying sentiment and perception of the media to generate media clips that include sentiment or information from the media itself.

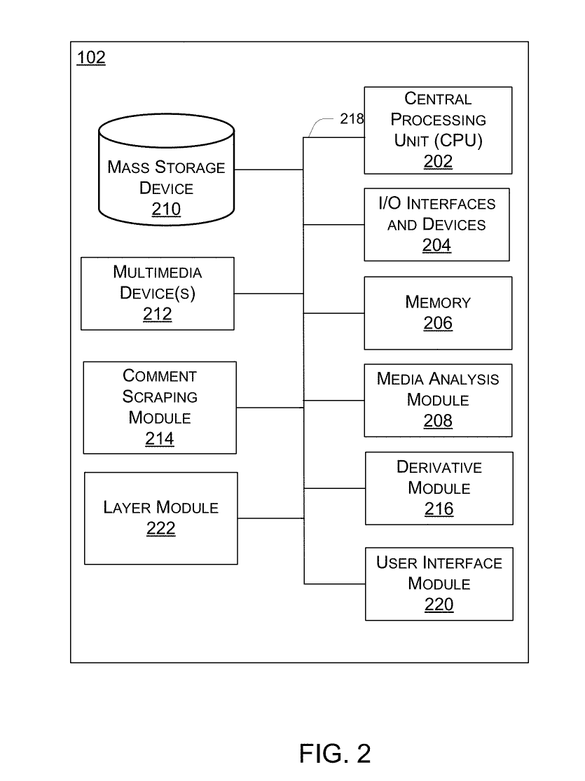

FIG. 2 is a block diagram corresponding to an aspect of a hardware and software device 200, which may comprise one or more of the devices of an example embodiment of the system 100 of FIG. 1. The hardware and software device 200 as discussed herein with reference to the block diagram of the system 100 may be included in any of the devices of the system 100 (e.g., the terminal 102, the computing devices 106, etc.). In some embodiments, the device 200 may comprise a system 200. Thus, the device 200 may be used to implement systems and methods described herein. In some embodiments, the device 200 includes one or more central processing units (“CPUs” or processors) 202, I/O interfaces and devices 204, memory 206, a media analysis module 208, a mass storage device 210, a multimedia module 212, a comment scraping module 214, a derivative module 216, a user interface module 220, a layer module 222, and a bus 218.

In some embodiments, certain modules described below, such as a CPU 202, I/O interfaces and devices 204, memory 206, a media analysis module 208, a mass storage module 210, a multimedia devices 212, a comment scraping module 214, a derivative module 216, a user interface module 220, a layer module 222, and a bus 218 may be included with, performed by, or distributed among different and/or multiple devices of the system 100. For example, certain user interface functionality described herein may be performed by the user interface module 210 of the terminal 102 of the system 100 and/or by the user interface module 220 of the computing device 106 of the system 100. Alternatively, or additionally, some functionality described herein in relation to a particular module may be combined with functionality from another module and performed by a combined module.

In some embodiments, the various modules described herein may be implemented by either hardware or software. In an embodiment, various software modules included in a component of the system 100 (e.g., the terminal 102) may be stored on the component of the system 100 itself, or on computer readable storage media or other component separate from the system 100 and in communication with the system 100 via the network 101 or other appropriate means.

The device 200 may comprise, for example, a computer that is IBM, Macintosh, or Linux/Unix compatible or a server or workstation (e.g., corresponding to the terminal 102). In some embodiments, the device 200 comprises a smart phone, a personal digital assistant, a kiosk, or a media player (e.g., corresponding to the computing devices 106). In some embodiments, the device 200 may comprise more than one of these devices.

The CPU 202 may control operation of the system 100. The CPU 202 may also be referred to as a processor. The processor 202 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The I/O interface 204, for any of the devices of FIG. 1, may comprise a keypad, a microphone, a touchpad, a speaker, and/or a display, or any other commonly available input/output (I/O) devices and interfaces. The I/O interface 204 may include any element or component that conveys information to a consumer or user of the device 200 and/or receives input from the consumer or user. In one embodiment, the I/O interface 204 includes one or more display devices, such as a monitor, that allows the visual presentation of media and/or data to the consumer. More particularly, the display device provides for the presentation of GUIs, application software data, websites, web apps, and multimedia presentations, for example.

In some embodiments, the I/O interface 204 may provide a communication interface to various external devices. For example, the device 200 is electronically coupled to the network 101 (FIG. 1), which comprises one or more of a LAN, WAN, and/or the Internet. Accordingly, the I/O interface 204 includes an interface allowing for communication with the network 101, for example, via a wired communication port, a wireless communication port, or combination thereof. The network 101 may allow various computing devices and/or other electronic devices to communicate with each other via wired or wireless communication links.

The memory 206, which includes one or both of read-only memory (ROM) and random access memory (RAM), may provide instructions and data to the processor 202. For example, inputs received by one or more components of the system 100 may be stored in the memory 206. A portion of the memory 206 may also include non-volatile random access memory (NVRAM). The processor 202 typically performs logical and arithmetic operations based on program instructions stored within the memory 206. The instructions in the memory 206 may be executable to implement the methods described herein. In some embodiments, the memory 206 may be configured as a database and may store information that is received via the user interface module 220 or the I/O interfaces and devices 204.

The device 200 may also include the mass storage device 210 for storing software or information (for example, the derivative work timeline or associated media clips, perception data, comparison data, etc.). Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. Accordingly, the device 200 may include, e.g., hardware, firmware, and software, or any combination therein. The mass storage device 210 may comprise a hard drive, diskette, solid state drive, or optical media storage device.

The media analysis module 208 may be stored in the mass storage device 210 as executable software code or an algorithm that is executed by the processor 202. The media analysis module 208 may be implemented in either or both of the terminal 102 and the computing device 106 of FIG. 1. This, and other modules in the device 200, may include various components, such as hardware and/or software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 2, the media analysis module 208 may analyze media files and media clips stored in the mass storage device 210 or accessible via the I/O interfaces and devices 204. For example, the media analysis module 208 may be configured to manipulate the media files and media clips after loading them from the mass storage device 210. The media analysis module 208 may also be used when generating the derivative works to identify portions of the media files and media clips based on input from the user (wherein the input from the user may be received via the user interface module 220 or the I/O interfaces and devices 204. In some embodiments, the media analysis module 208 may be used in aggregating and analyzing media files based on user inputs. This analysis may involve identifying portions of the media files that meet requirements as set by the user.

In some embodiments, the derivative module 216 may generate and interpret timelines for creating derivative works based on existing media. The derivative module 216 may be implemented in either or both of the terminal 102 and the computing device 106 of FIG. 1. In some embodiments, the derivative module 216, in operation on the terminal 102 and creating the timeline, may receive information from a user and generate a timeline of one or more media portions and media manipulations that result in the formation of a derivative work. Such a derivative work may comprise links to the media portions and manipulations to be applied to the media portions, and therefore may be of reduced size for communication and processing by viewing components. Accordingly, the timelines of derivative works may be more easily communicated and processed by consumers, thus improving the generation and consumption of derivative works. Similarly, the derivative module 216 may be used by a consuming device (e.g., the computing devices 106) when viewing the derivative work. Accordingly, the derivative module 216 may be used to receive and parse the timeline so as to identify links to target media portions and apply the manipulations to the obtained media portions to create the derivative work for viewing and/or consumption by the computing device 106.

In some embodiments, the derivative module 216 may perform various functions in generating the derivative work. For example, in some embodiments, the derivative module 216 may comprise a video editor or video player, dependent on whether the derivative work is being generated (e.g., at the terminal 102) or consumed/viewed (e.g., at the computing device 106). In some embodiments, the derivative module 216 may use stack media containers that include space/indicators for media elements and effects in a list format. The stack containers may be grouped in a “bounding box” such that they appear as a single media container for each derivative work. In some embodiments, any other formatting may be used for the communication of the derivative work files and effects. The derivative module 216 may generate a timeline for the derivative work. The derivative module 216 may be used to coordinate media references, effects, properties, timing, filters, etc., for the derivative work. Accordingly, the derivative work may comprise the bounding box including the timeline with essential details of the derivative content in a scheduled manner. In some embodiments, the bounding box and the stack media containers may only include references to the corresponding media without including the media itself. By communicating the media as references only, storage and/or transmitted data is reduced, thereby improving generation and viewing of the derivative works.

The media containers may include the reference (e.g., a web link) to the corresponding media, identifiers of selected portions of the corresponding media (e.g., start/end timestamps), and identifiers or details of any effects or filters to be applied to the corresponding media. The derivative work (e.g., via the bounding box, may include a media container for each “clip” of media in the derivative work. For example, the derivative work may include a clip from each of two separate media files. Thus, the derivative work may comprise two containers, one for each clip, where each container includes the specific timestamp info (start/end times) and filter/effect information for the media clip in the container. The derivative module 216 may generate the derivative work by assembling as many containers as requested by the user. Thus, each container may be self-contained and the timeline of the bounding box may indicate how the derivative module 216 is to coordinate each of the containers when displaying the derivative work.

When the derivative work is consumed, the derivative module 216 may load the timeline and media containers from the derivative work. The derivative module 216 may identify the order that the media containers are to be accessed (e.g., based on the order in which the media clips are identified in the timeline) and the effects that will be applied to the clips. The derivative work may be consumed by following the timeline, where each container is consumed based on the information in the container (e.g., reference to the media and the start/end time stamps). The derivative module 316 may obtain the relevant media clip based on the reference and start/end timestamps. The derivative module 216 may then identify the effects and filters to be applied to the media in the container. Once the media clip and effects/filters are applied and/or stored in memory, the derivative module 216 proceeds to consume a subsequent container, assuming one exists. If no other containers exist, then the derivative module 216 is done playing/consuming the derivative work. Accordingly, the derivative module 216 will apply the effects to the media clips in the proper order according to the timeline. As each container is consumed, the derivative module 216 may proceed to a subsequent container until the derivative module 216 identifies an empty container or the timeline ends.

For example, when creating or generating the derivative work, the derivative module 216 may receive a file or data object via the network 101 or as indicated by the user. The file may include a location of or data for an initial media file that will be used as a first portion of the derivative work. The derivative module 216 may load the media file and then receive, from the user, an indication of start/stop times for a clip that the user desires to obtain from the media file. For example, while the initial media file may have a total length of 2 minutes, the user may only want a clip including a 30 second period starting at the 1 minute mark. The user may also identify one or more effects or manipulations to apply to the clip. The reference (e.g., link) to the video clip, the start/end timestamps for the desired clip, and the effects or manipulations to apply to the video clip may be stored in a container. Additional clips and effects may be added in individual containers. The sequence of containers may be established based on an order identified by the user or by an order in which the user obtains the reference media. Then, the containers may be communicated to a consuming device (e.g., the computing device 106) for viewing. Communicating these containers (e.g., in the bounding box) may involve reduced communications as compared to communicating the actual video files, thus improving communication of the derivative work.

In some embodiments, the derivative module 216 may also provide improved derivative works that use clips or portions from the same media file multiple times. For example, when media is read from links for multiple containers that reference a single media file or location, multiple copies of the media file will not be needed, improving modularity of media files and derivative works.

In some embodiments, the derivative module 216 may automatically identify any portions of copyrighted media files in a particular derivative work. This may provide for fair and informed copyright management. In such embodiments, the derivative module 216 may determine whether a reference media file is copyrighted. In some embodiments, this may be determined based on an analysis of the reference or link to the media file. For example, a reference media file posted a particular company's website may be determined to be copyrighted by that company based on the web-link to the media file. Alternatively, or additionally, the derivative module 216 may analyze the media file itself to determine if any copyright information is embedded in the media file. In some embodiments, the device 200 may generate an alert to the user regarding the copyrighted media file. In some embodiments, the derivative module 216 may indicate copyrighted media in a flag in the container or in some similar manner. In some embodiments, the derivative module 216 may identify the copyrighted media and generate notifications regarding the copyrighted media, allowing the user to obtain authorization for the particular copyrighted materials.

The derivative module 216 may simplify manipulation of derivative works. For example, as each media clip is isolated in the container with corresponding timestamp information and effects, media clips in a timeline may be easily interchanged or swapped in/out without having to generate an entire new derivative work. For example, a user may edit a derivative work to replace a reference to a media file, any effects applied to the media file, and/or timestamp information indicating relevant portions of the media file. In some embodiments, the user may edit the derivative work to rearrange the media clips in the timeline.

The methods and systems described herein in relation to the derivative module 216 for creating, editing, and consuming derivative works may be applied to any media files, including video, music, audio, photos, gif files, etc.

In some embodiments, the comment scraping module 214 may be used in conjunction with one or both of the media analysis module 208 and the derivative module 216. The comment scraping module 214 may collect available discussion and associated data regarding a specific media file or content. The comment scraping module 214 may selectively collect a portion or all of the available discussion and associated data for the specific media file or content, based on the consumer's input. The comment scraping module 214 may use these inputs from the consumer to identify and collect comments, discussions, video clips, associated data, etc., from the identified (and similar) websites for processing. In some embodiments, the sources for the comments, discussions, video clips, etc., may be online or offline sources. In identifying and collecting this information, the comment scraping module 214 may sort the collected information by time in relation to the original media file or content. The sorted information may then be used by the comment scraping module 214 to build groups of information (e.g. comments (e.g., text comments, interest indicators, feedback indicators, etc.), discussion, live chats, video clips, etc.) for different time periods. In some embodiments, the associated data may include data regarding the event captured in the media file and/or the media file itself. For example, the associated data may include scores from the event, statistics of one or more participants of the event, occurrences of a particular type during the event, etc. This data may be based on an analysis of information regarding the event itself, for example embedded into the media file stream. Thus, the comment scraping module 214 may analyze the media file to identify details of the event itself and provide textual, numerical, or similar data for analysis and grouping.

The comment scraping module 214 may implement one or more methods of web scraping, application programming interface (“API”), data importation from available providers (e.g., social media, discussion, video clip, etc., websites), or media analysis to build a collection of data associated with the media file. The collection of data may be accessed by one or more other components or modules of the device 200.

In some embodiments, the comment scraping module 214 may utilize the collected and identified information to identify times during the recorded or streaming event using at which events or moments of interest occurred. The comment scraping module 214 may use the identified times to build a timeline of events or moments of interest. The comment scraping module 214 (or another module of the device 200) may then synchronize or align the timeline of events or moments or interest with the timeline of the recorded or streaming event. In some embodiments, the comment scraping module 214 may use natural language processing and/or other parsing and processing methods to identify the times of the events or moments of interest to build the timeline of events or moments of interest. In some embodiments, the comment scraping module 214 may use numerical data (based on either the collected comments or the data from the event itself) to identify a most relevant portion of the recorded or streaming media. For example, if the numerical data being monitored is a score for a team, then the comment scraping module 214 may identify associated events based on a change of the numerical data.

This timeline of events or moments of interest may indicate general sentiment or emotion of viewers for the one or more events or moments of interest at particular times along the timeline. For example, the comment scraping module 214 may identify comments from social media regarding the recorded or streaming event as being excitement (e.g., for a particular play or scoring event) or anger based on an analysis of the actual words and language being used (e.g., text from the social [media] posts or audio from a recorded commentary, etc.). Accordingly, the comment scraping module 214 may identify an event or moment of interest that occurs during the recorded or streaming event based on the comments and other information (e.g., frequency of comments, source of comments, etc.) collected by the comment scraping module 214. In some embodiments, the processor 202 or another component of the device 200 may use the information collected by the comment scraping module 214 to generate the timelines and identify the events or moments of interest based on the collected information.

For example, a consumer using a computing device 106 may wish to identify all scoring events during a championship video game match. The consumer may access the terminal 102 (via the network 101 and the computing device 106) and request the identification of all scoring events for both teams/players during the championship video game match. The initial request may identify the championship video game match and one or more sources for comments, discussions, or video clips. For example, the consumer may identify social media websites as sources for comments, discussions, and similar content. The consumer may also identify one or more websites where video clips and corresponding commentary of the championship video game match are available.

The comment scraping module 214 may analyze and parse the identified social media websites to determine if any of the requested scoring events occurred in the championship video game match. The comment scraping module 214 may use the natural language processing (or similar strategies) to parse the comments and identify the scoring events based on the comments identified on the social media websites. For example, comments from the social media may congratulate or include exclamations at scoring events. A large frequency of such comments at or within a given period may be indicative of a scoring event, where the frequency of such comments adds weight to the likelihood of the event being a scoring event. Alternatively, or additionally, the comment scraping module 214 may analyze data from the championship video game match (e.g., details of the match itself) to identify scoring events by monitoring the scores of the various competitors/teams. The comment scraping module 214 may identify times that the monitored events occur and provide the times for further analysis. In some embodiments, the comment scraping module 214 monitoring the scores may identify scoring events based on identifying changes in the monitored score.

The device 200 also includes the user interface module 220. In some embodiments, the user interface module 220 may also be stored in the mass storage device 210 as executable software code that is executed by the processor 202. In the embodiment shown in FIG. 2, the device 200 may be configured to execute the user interface module 220 to perform the various methods and/or processes as described herein.

The user interface module 220 may be configured to generate and/or operate user interfaces of various types. In some embodiments, the user interface module 220 constructs pages, applications (“apps”) or displays to be displayed in a web browser or computer/mobile application. In some embodiments, the user interface module 220 may provide an application or similar module for download and operation on the terminal 102 and/or the computing devices 106, through which the media consumer may interact with the terminal 102. The pages or displays may, in some embodiments, be specific to a type of device, such as a mobile device or a desktop web browser, to maximize usability for the particular device. In some embodiments, the user interface module 220 may also interact with a client-side application, such as a mobile phone application (an “app”), a standalone desktop application, or user communication accounts (e.g., e-mail, SMS messaging, etc.) and provide data as necessary.

The layer module 222 may perform processing functions of various inputs as described as layers herein. The layer module 222 may provide processing of online discussion comments or posts (e.g., as an online discussion layer), where the layer module 222 analyzes comments or posts from online forums to identify occurrences, as described herein. The layer module 222 may provide processing of online media clips (e.g., as an online media clip layer), where the layer module 222 analyzes media clips from online forums to identify occurrences, as described herein. The layer module 222 may provide processing of spectator media (e.g., as a spectator media layer), where the layer module 222 analyzes media including spectator reactions and interactions in various media to identify occurrences, as described herein. The layer module 222 may provide processing of source data (e.g., as a source material layer), where the layer module 222 analyzes data from the source (e.g., the game or event) to identify occurrences, as described herein. The layer module 222 may provide processing of source media data (e.g., as a source media data layer), where the layer module 222 analyzes the source media file itself to identify occurrences, as described herein. In some embodiments, the layer module 222 may be configured to merge outputs from multiple layers based on multiple layers being used to analyze or identify occurrences. The layer module 222 may also output the identified occurrences to a storage location (e.g., the mass storage device 210 or the memory 206) or the user interface module 220. Though shown as an individual component of the device 200, the functions of the layer module 222 may be performed by the processor 202 or a combination of components (e.g., the processor 202, the memory 206, the I/O interfaces and devices 204, etc.).

For example, as described herein, the terminal 102 may be accessible to the consumer via a website (e.g., the website hosting a media file or the terminal 102 website). The website for the terminal 102 may provide access to the timeline building for derivative works or for the analyzing and generating of the media automatically. In some embodiments, a downloadable app or a widget may provide for analyzing media and/or derivative work generation and/or viewing functionality. For example, a consumer using the computing device 106 may access the terminal 102 via the website to generate, playback, or analyze media. For example, the consumer may wish to generate or playback a derivative work based on a collection of videos including particular outcomes in video game tournaments (e.g., victories). Accordingly, the terminal 102 may provide an interface via which the consumer may enter links or addresses to media that is to be used in the derivative work and any manipulations to apply to the media. Alternatively, or additionally, the consumer may wish to have the terminal 102 analyze a media file and identify particular events in the media file. For example, the consumer may wish to have the terminal 102 analyze a media file from an online video game tournament and identify moments when a team or player scored points. Accordingly, the terminal 102 may provide the interface via which the user selects or identifies the media file and provides inputs regarding what events the terminal 102 uses in analyzing the media file. Additionally, or alternatively, the terminal 102 may also provide a selection of available sources to use for the analysis of the media file.

The device 200 may also include one or more multimedia devices 212, such as speakers, video cards, graphics accelerators, and microphones, for example.

The various components of the device 200 may be coupled together by a bus system 218. The bus system 218 may include a data bus, for example, as well as a power bus, a control signal bus, and a status signal bus in addition to the data bus. In different embodiments, the bus could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of the device 200 may be combined into fewer components and modules or further separated into additional components and modules than that shown in FIG. 2.

In some embodiments, the device 200 may perform one or more methods of automatically curating and categorizing media based on sentiment analytics. As described herein, the processor 202 (or one or more other modules of the device 200) of the terminal 102 or the computing device 106 may analyze the original media content and categorize the original media content, or portions thereof. Accordingly, the device 200 may automatically identify “highlights” based on requests from the user. Accordingly, after gathering and analyzing the data regarding the event (e.g., via the media analysis module 208 and/or the comment scraping module 214), the device 200 may further use the analysis and the data to identify portions of the media file that pertain to the highlights requested by the user. For example, a user may identify a media file from a recorded football game and may want highlight videos of all touchdowns scored by either team. The device 200 may obtain the media file and obtain information regarding touchdowns scored during the football game from corresponding social media, commentary, and/or the media file itself. The device 200 may identify the touchdowns based on analyzing language used in the corresponding social media (e.g., exclamatory statements, congratulations, etc.) and the commentary or by monitoring score information embedded in the media file itself (e.g., identifying when a score value in the media file changes by six points). Accordingly, the device 200 may identify times in the media file (after synchronizing or aligning timing information between the obtained information and the media file) at which the touchdowns occur and may generate clips of the media file based on the identified times. In some embodiments, the output may be an identification of a single, most relevant portion of the media file. Alternatively, or additionally, the end result or output generated by the device 200 may be a highlight reel of all touchdowns scored during the football game. In some embodiments, the user may identify a particular sentiment or category as opposed to an event such as touchdowns. Regardless of the request from the user, the device 200 may provide the most relevant portion(s) of the media file based on the analysis provided herein. In some embodiments, the device 200 may analyze multiple media files and may generate the highlights based on the multiple files. For example, the consumer may request all goals scored in all soccer games for a particular team in a tournament, where each game is its own media file. The device 200 may analyze each of the games, obtain corresponding comments from social media, etc., and generate a single output highlight video or link with the goals from each game in the tournament. In some embodiments, generating the highlight video may utilize systems and method described herein.

In some embodiments, the device 200 may identify media preferences of a media consumer and suggest media based on the consumer's current mood. In some embodiments, the device 200, (e.g., via the processor 202) may identify all media that the device 200 is asked to analyze by the media consumer and store details of the analyzed media in a database. In some embodiments, the media itself may be stored based on a most prevalent sentiment or mood expressed in the media or by other people who viewed or experienced the media. For example, media comprising movie about a wedding may have social media comments described the romantic event, which the device 200 identifies when analyzing the media and identifying sentiment and perception of the media. Accordingly, the device 200 may store information regarding that media (e.g., in the memory 204 or the mass storage device 210. The stored information may include details of the type of media viewed by the user. As the user views more media analyzed by the device 200, the device 200 may determine a type of media preferences of the user (e.g., determine the category or genre) the user enjoys viewing (e.g., by comparing a number of romantic media viewed vs. comedy media viewed). Based on the determined type of media preference, the device 200 may identify other media with that same type by analyzing information of other media (e.g., reviews and/or social media for new movies). Thus, if the user enjoys romantic movies, then the device 200 may identify a new romantic movie that the user has not seen (e.g., as determined by the device not having any stored information regarding the new romantic movie) and recommend the same to the user.

In some embodiments, the device 200 may automatically analyze and categorize media (e.g., popular media, etc.). For example, the device 200 may be used by a user that monitors all content produced by a particular website or entity. Alternatively, or additionally, the device 200 may monitor popular media and analyze it to categorize it based on sentiment. Additionally, the device 200 may highlight or identify one or more portions in the popular media based on analysis of related social media and data in the corresponding media file.

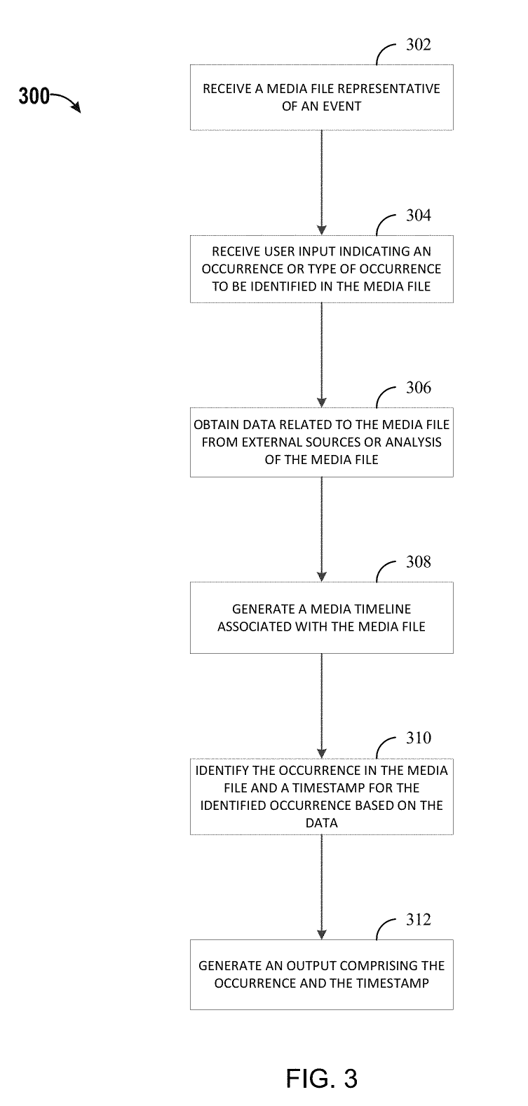

FIG. 3 is an example of a flowchart for a method 300 of automatically analyzing and generating media based on an event, in accordance with an exemplary embodiment. The method 300 may be performed by one or more of the components of the device 200 of FIG. 2. For example, the method 300 may be performed by the processor 202 of the terminal 102 or the derivative module 216 of the terminal 102. In some embodiments, the method 300 may be performed by a combination of components of the device 200, including the processor 202, the memory 206, mass storage device 210, the I/O interfaces and devices 204, the media analysis module 208, the comment scraping module 214, and the user interface module 220.

At block 302, the device 200 receives a media file for analysis. For example, the media file may be provided by a user of the device 200. The media file may include live or recorded content of an event. In some embodiments, the user may provide the media file itself or a reference (e.g., a web link) to the media file. When the user provides the reference to the media file, the device 200 may obtain the media file via the reference. The media file may be stored in the memory 206 or the mass storage device 210. Once the device 200 receives the media file, the device 200 proceeds to block 304.

At block 304, the device 200 receives user input indicating an event or type of event to be identified in the media file. For example, the user input may request that the device 200 identify halftime in a game or all scoring events in the game. In some embodiments, the user request may be stored in the memory 206 and may be associated with corresponding terms, etc. that will identify the event or type of event identified by the user. For example, if the user requests identification of “scoring events,” the device 200 may also expand the phrase “scoring events” to include “points,” “score,” and other similar terms to better identify the requested events. Once the device 200 receives the user input, the device 200 proceeds to block 306.

At block 306, the device 200 obtains data related to the media file from one or more sources. In some embodiments, the data may include online comments (e.g., comments from social media, commentators, etc.), online media clips, spectator/reaction media, data from the media file, and/or data from a source of the media file. This data may be used to identify the user requested events or types of events. Once the data is obtained, the device 200 proceeds to block 308.

At block 308, the device 200 generates a media timeline associated with the media file. The media timeline may be timing information provided with the media (e.g., information that tracks time through the media file). Once the media timeline is generated, the device 200 proceeds to block 310.

At block 310, the device 200 identifies the event or type of event may comprise analyzing the media file and the related data, as described herein. Identifying the timestamp corresponding to the event or type of event may comprise determining the time at which the event or type of event occurs in the obtained data. The obtained data may include its own timeline, and the identified timestamp may correspond to the timeline of the data. In some embodiments, the device 200 may analyze the media file and the obtained data to identify all occurrences of the event (and all corresponding timestamps for the events). Once the media timeline, the event timestamp, and the event itself are identified, the method 300 proceeds to block 312.

At block 312, the device 200 generates an output identifying the event or type of event and the timestamp. In some embodiments, the output may comprise a spreadsheet or similarly formatted document that includes one or more of the media file analyzed, the event or type of event identified, and start/end timestamps for the event or type of event. In some embodiments, the output may comprise a list or display of video clips that include the events. In some embodiments, the output may further comprise timestamps that are adjusted to identify the event or type of event in the media file in relation to the timeline of the media file to allow a viewer to view the event in the media file. This may involve the device 200 defining a synchronization factor that is used to synchronize the timeline of the media file with the timeline of the obtained data. When the device 200 identifies multiple events in the media file, the output may include all of the identified events and all corresponding timestamp information.

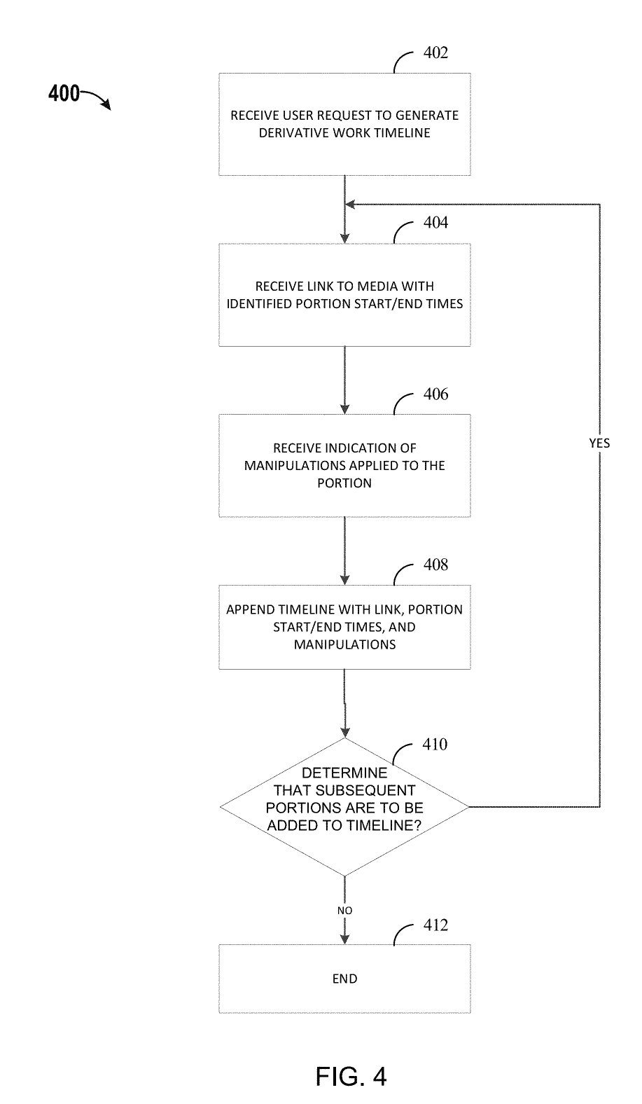

FIG. 4 is an example of a flowchart for a method 400 of generating a timeline for a derivative work based on one or more available media, in accordance with an exemplary embodiment. The method 400 may be performed by one or more of the components of the device 200 of FIG. 2. For example, the method 400 may be performed by the processor 202 of the terminal 102 or the derivative module 216 of the terminal 102. In some embodiments, the method 400 may be performed by a combination of components of device 200, including the processor 202, the memory 206, mass storage device 210, the I/O interfaces and devices 204, the media analysis module 208, the comment scraping module 214, and the user interface module 220.

At block 402, the device 200 receives a user request to generate a derivative work. Generating the derivative work may comprise generating a timeline for the derivative work, where the timeline indicates how media clips used to form the derivative work are arranged, when to play particular media clips, and when to apply any effects or manipulations to the media clips. When the device 200 receives the user request, the device 200 may create an empty or blank timeline via a bounding box with at least one container. Once the timeline, bounding box, and/or container are created, the method 400 proceeds to block 404.

At block 404, the device 200 receives a reference to a media file with identified portion start/end times. The reference to the media file may comprise a web link or similar reference information that provides the device 200 with a location where the media file of interest may be obtained. The reference information may be used by the device 200 to obtain (e.g., download) the media file. In some embodiments, the device 200 also receives identified start/end timestamps. These timestamps may identify a start time and an end time for the media clip. For example, the timestamps may identify a 15 second portion of a minute-long media file. In some embodiments, the reference and the start/end timestamps may be saved to the memory 206 for further processing. Once the reference and timestamps are received, the method 400 proceeds to block 406.

At block 406, the device 200 receives an indication of manipulations to apply to the portion or media clip. In some embodiments, the device 200 may receive timestamps for when the manipulations are to be applied to the media clips. In some embodiments, the timestamps may be in relation to the media clips or portions. The device 200 may also receive details regarding the manipulation to apply to the portion. For example, the device 200 may receive details regarding a filter or visual effect to apply to the portion. Once the device 200 receives the details of the manipulations to apply to the portions, the device 200 may proceeds to block 408.

At block 408, the device 200 may save the reference to the media file, the portion start/end timestamps, and details of the manipulations to apply to the portion in the container of the bounding box and timeline. Accordingly, the container may generally contain a link to the media file and information regarding what portion of the media file is of interest and what manipulations to perform on the media file. Once the container is updated to include the information for the portion or media clip, the device 200 may proceed to block 410.

At block 410, the device 200 may determine whether to include additional media clips or portions in the timeline or derivative work. If the device 200 determines to include additional media clips or portions (e.g., based on an input from the user), then the device 200 may proceed to block 412. If the device 200 determines not to include additional media clips or portions (e.g., based on the user input), the device 200 may proceed to block 414.

At block 412, the device 200 may add another container to the bounding box and timeline for an additional media clip or portion to be added to the derivative work. Once the additional container is added, the device 200 proceeds to block 404 and repeats block 404-412 until the device 200 determines at block 410 that no additional media clips or portions are to be included. At this point, when no additional media clips or portions are to be included, the device 200 proceeds to block 414, where the method 400 ends.

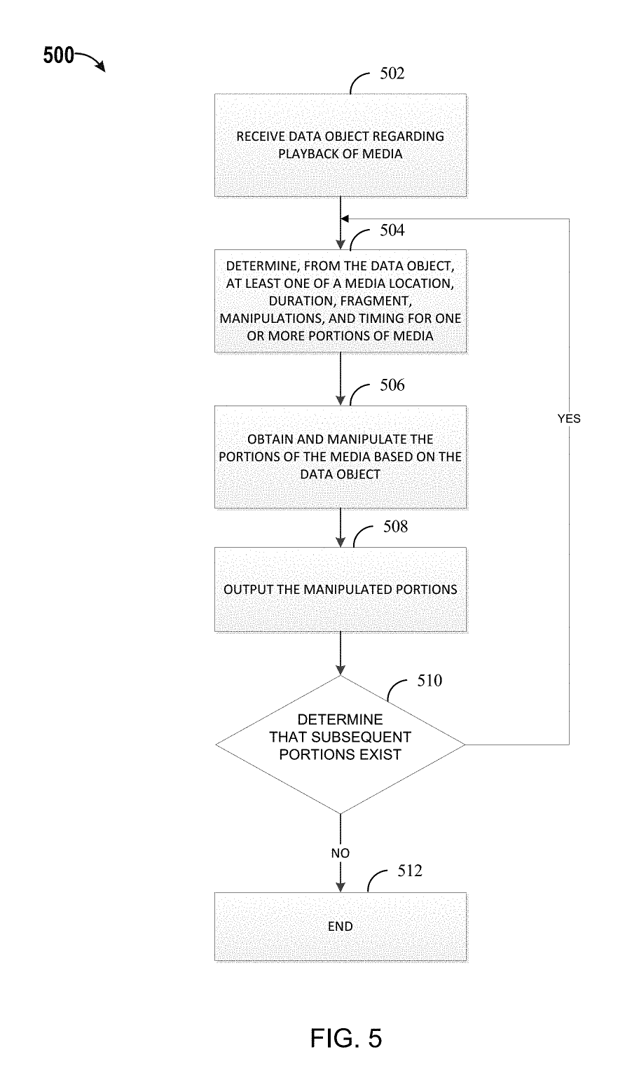

FIG. 5 is an example of a flowchart for a method 500 of viewing a derivative work based on a timeline referencing one or more available media, in accordance with an exemplary embodiment. The method 500 may be performed by one or more of the components of the device 200 of FIG. 2. For example, the method 500 may be performed by the processor 202 of the terminal 102 or the derivative module 216 of the terminal 102. In some embodiments, the method 500 may be performed by a combination of components of device 200, including the processor 202, the memory 206, mass storage device 210, the I/O interfaces and devices 204, the media analysis module 208, the comment scraping module 214, and the user interface module 220.

At block 502, the device 200 receives a user request to view a derivative work. The request comprises a data object (e.g., the bounding box) including various parameters of the derivative work. The device 200 may identify the timeline of the data object and identify a first container of the bounding box. The timeline may indicate how media clips used to form the derivative work are arranged, when to play particular media clips, and when to apply any effects or manipulations to the media clips. When the device 200 receives the user request, the device 200 may access the first container. Once the timeline, bounding box, or container are received, the method 500 proceeds to block 504.

At block 504, the device 200 identifies or determines, from the first container, at least one of a media reference, start/end timestamps, and manipulations to apply to the media clip or portion. The reference to the media file may comprise a web link or similar reference information that provides the device 200 with a location where the media file of interest may be obtained. In some embodiments, the timestamps may identify a start time and an end time for the media clip. For example, the timestamps may identify a 15 second portion of a minute-long media file. In some embodiments, the reference and the start/end timestamps may be saved to the memory 206 for further processing. Once the reference, the timestamps, and the manipulations information are received, the method 500 proceeds to block 506.

At block 506, the device 200 uses the reference to obtain the media file and identifies the relevant portion or clip based on the timestamps. The device 200 also applies the manipulations from the container to the media clip or portion according to the information received in the container. In some embodiments, the device 200 may determine times when the manipulations are to be applied to the media clips based on information in the container. In some embodiments, the timestamps may be in relation to the media clips or portions. The device 200 may also receive details regarding the manipulation to apply to the portion. For example, the device 200 may receive details regarding a filter or visual effect to apply to the portion. Once the device 200 obtains the media clip or portion and applies the manipulations, the device 200 may proceeds to block 508.

At block 508, the device 200 may output the manipulated media clip or portion, for example, to a monitor or television (or another media output device). Once the media clip is output, the device 200 may proceed to block 510.

At block 510, the device 200 may determine whether to additional media clips or portions are included in the timeline or derivative work. If the device 200 determines that additional media clips or portions are included (e.g., based on determining that other containers exist in the bounding box), then the device 200 may proceed to block 512. Esportslf the device 200 determines that additional media clips or portions are not included (e.g., based on no additional containers existing in the bounding box), the device 200 may proceed to block 514.

At block 512, the device 200 may load another container from the bounding box and timeline for an additional media clip or portion of the derivative work. Once the additional container is loaded, the device 200 proceeds to block 504 and repeats blocks 504-512 until the device 200 determines at block 510 that no additional media clips or portions are included. At this point, when no additional media clips or portions are included, the device 200 proceeds to block 514, where the method 500 ends.

In some embodiments, the systems and methods disclosed herein may be focused on esports, video blogging, sports, comedy, or any other livestreaming or recorded video or media that is generally shared with viewers. This media may also include virtual or augmented reality sessions, 360-degree recordings, 3D recordings, audio, photos, GIFs, etc. The systems and methods described herein may be used to identify one or more occurrences or occurrence types in a source media file of an event. The source media file may be the recording or livestream of the event (e.g., a livestream of a shooter video game competition or a recording of a college or professional football game). In some embodiments, the systems and methods described herein may automatically search source media files to identify moments of interest (e.g., occurrences or occurrence types). In some embodiments, the systems and methods described herein may work with human input to identify desired moments of interest.

As described herein, an occurrence may comprise a particular or repeatable moment or action during the event, such as a scoring moment/action/event that can generally be identified in the source media file based on the event itself. For example, in a football game (real or video game) touchdowns or other scoring events are generally tracked as part of the event itself. Accordingly, such touchdowns may be occurrences that can be identified for searching in the source media file of the football game. Similarly, kills in shooter games or other accomplishments in role-playing games may be occurrences that can be identified based on the occurrences being tracked as part of the game itself. Thus, the occurrence may be defined by a particular result in the game or event itself. An occurrence type may be directed to the sentiment and/or perception created or caused in an audience or participant, etc., by a moment during the event. For example, laughter from the audience or the participant during a gaming session recording or livestream may identify a funny moment or occurrence during the event. Similarly, laughter during a comedy routine may indicate a joke was told.

In some embodiments, the systems and methods may utilize “layers” or “layered” processing. In or under the layered processing approach, the systems and methods may use different layers to collect and analyze data for processing in conjunction with the source media file of the event to identify desired or requested occurrences or occurrence types. For example, each layer may provide a unique or different way (e.g., based on different input data) to identify, categorize, and/or describe requested occurrences in the source media file. In some embodiments, the systems or methods may apply these layers individually or independently or in a synchronized manner. When synchronized, the systems and methods ensure that data for a given timestamp from one layer is relevant to the same occurrence in another layer being synchronized. Accordingly, the occurrences that are independently identified in each layer can be “aggregated” into one or more occurrences between all of the layers. In some embodiments, the systems and methods may also customize results (e.g., outputs) based on user setup or requests.

The systems and methods may include receiving inputs including the source media file of the event and including additional information for use in analyzing the source media file and identifying occurrences of interest. For example, the systems and methods may receive an input of a location or reference for the source media file (e.g., a web-link as described herein). The systems and methods may also receive an input from the user regarding types of clips desired (e.g., the occurrences or types of occurrences desired) to be identified in the source media file. For example, the user may request or specify that scoring occurrences or funny occurrences be identified or that all occurrences involving a particular competitor or team in a competition be identified. In some embodiments, the user may request or specify that particular content (e.g., occurrences or types of occurrences) be excluded. For example, the user may wish to exclude all non-game clips when the source media file is a competition or game with advertisements or audience interaction or camera views. Thus, the systems and methods described herein may generate an output only including media clips or portions that involve portions of the gaming itself with all advertisements and/or audience views, etc., removed from the output. In some embodiments, one of the layers may allow the user to provide example clips or data of the desired occurrences or occurrence type. For example, if the user wants to identify scoring occurrences, the user may provide a sample clip of a scoring occurrence that the user wants to capture or identify. In some embodiments, the inputs also include threshold levels for each layer being used in the analysis of the source media file. For example, the input may instruct the systems or methods to only identify media clips or portions when the systems or methods are more than 50% confident that the identified media clips/portions do identify the requested occurrence. In some embodiments, the confidence is calculated in a same or different manner for each layer. With regard to the online discussion layer, a frequency of comments (e.g., relating to sadness, excitement, etc.) may be generated, where 1.0 is a maximum frequency or number of comments in a given time period (e.g., 1 second) throughout the source media file and 0 is no comments during that period. In some embodiments, the confidence may be specific to a particular type of comment (e.g., comments indicating sadness vs. excitement) such that there is a difference confidence range for each type of comment or sentiment. Additionally, the confidence value based on number of comments may be further adjusted based on quality and/or content of the comments. For example, second 105 of a media file may have a confidence of 0.8 in view of a high number of comments. However, if all of the comments were posted by a single entity or by automated posting system (e.g., bots), the confidence value may be reduced accordingly (e.g., down to almost zero). If only a small number of the comments were from bots or a single entity, then the confidence value may not be reduced substantially. In some embodiments, any of the other layers may calculate confidence as described herein. Additionally, or alternatively, the inputs may also include layer weights, where different layers are weighted differently for processing purposes.

As described herein, five different layers may be identified for collecting and analyzing data. In some embodiments, more or fewer layers may be identified. As described herein, the five identified layers include: online discussion sources, online media clip posts, media of a spectator watching the original event, data from the source itself, and data generated from an analysis of the source media file (e.g., video and/or audio of the source media file). Each of the layers may be handled differently in collecting data, processing the data, and identifying occurrences in the source media file based on the data. Each layer may be processed or performed by one or more components of the device 200. For example, the online discussion layer may be processed by the processor 202 of the device 200. Similarly, each of the layers described herein may be processed by one or more components of the device 200. Thus, each of the processes or functions described herein in relation to the online discussion layer (and the other layers) may be performed by one or more components of the device 200.

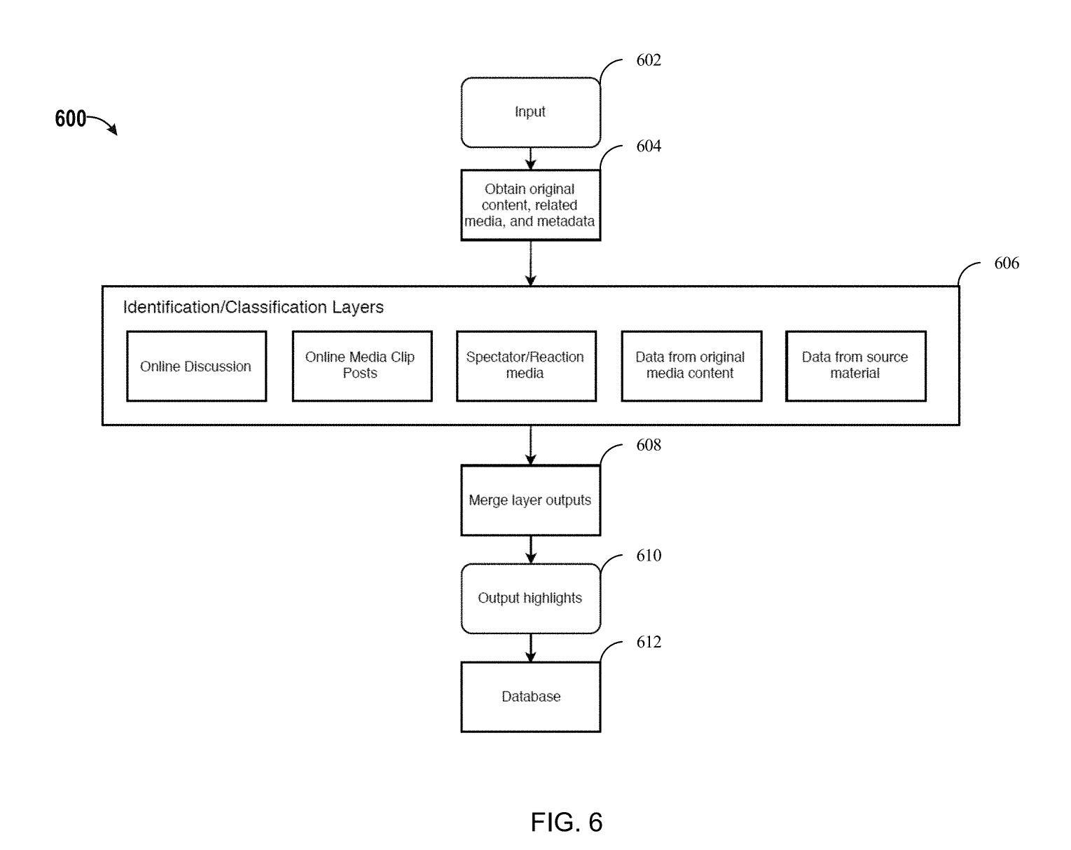

FIG. 6 depicts a diagram 600 of a system and corresponding inputs/outputs for identifying, categorizing, and/or describing occurrences in a source media file of an event. The diagram 600 includes an input block 602 for the system. In some embodiments, the different blocks of the diagram 600 may represent or be performed by components of the device 200. In some embodiments, input block 602 may correspond to one or more of the I/O interfaces and devices 204 or the user interface module 220 of FIG. 2. The input block 602 may provide for the receiving of information used by the system to identify, categorize, and describe the occurrences. The input block 602 may allow the system to obtain the source media file, related media (such as alternative perspectives or camera angles, additional content, behind the scenes views, other video of the same event as the source media file (such as audience view)), and metadata, as shown in block 604. In some embodiments, the input block 602 may also provide for input of user inputs (not shown).

Block 606 shows how the system may utilize the different layers to process the input received at block 604. In some embodiments, the different layers may correspond to operation of different algorithms or functionality of the layer module 222 or the processor 202 or other components of the device 200. For example, the layers include an online discussion layer, an online media clip layer, a spectator media layer, a source material layer, and a source media data layer. The system may use one or more of these layers to process the received input information to identify occurrences in the source media file. In some embodiments, when multiple layers are used, the outputs from the layers may be combined or merged at block 608. Once the outputs are merged and weighted accordingly, the outputs (e.g., identified occurrences) may be output as highlight clips at block 610. The outputs may include start/end times and a description or tag as generated by the layer(s) applied to explain what occurrence the clip includes. In some embodiments, the highlights may be output to a database (e.g., the mass storage block 210 or the memory 206) at block 612.

When more than one layer is used to identify occurrences, each layer may be weighted differently when aggregating the results of the layers. For example, occurrences identified by the source media data layer may be weighted more highly than the spectator media layer. In some embodiments, the layers may be synchronized by identifying the same occurrence in each layer and generating offsets to align the occurrences. In some embodiments, other methods of synchronizing layers may be used (e.g., identify offsets from shared time sources (e.g., game time) or source time references. Thus, once all layers are synchronized with the source media file time (e.g., based on the offsets, etc., discussed herein), each layer may return one or more of the following: start/end pairs (identifying start/end times for each identified occurrence), descriptions/tags corresponding to each start/end pair, and a confidence/rating for each start/end pair. Based on the confidences or weights assigned to each layer (e.g., from the user input), the systems or methods may determine a final listing of start/end pairs along with the associated data (e.g., descriptions/tags corresponding to the start/end pairs and rankings of the pairs) is formed. This weighting may be different for different types of occurrences.

In some embodiments, if the weights or confidences are not provided by the user, they may be generated based on an occurrence or occurrence type requested. For example, if funny clips are desired, results of the online discussion layer likely are more valuable than results from the source media data layer. Alternatively, or additionally, if scoring clips are desired, results of the source media data layer may be more reliable or valuable than results of the spectator media layer.

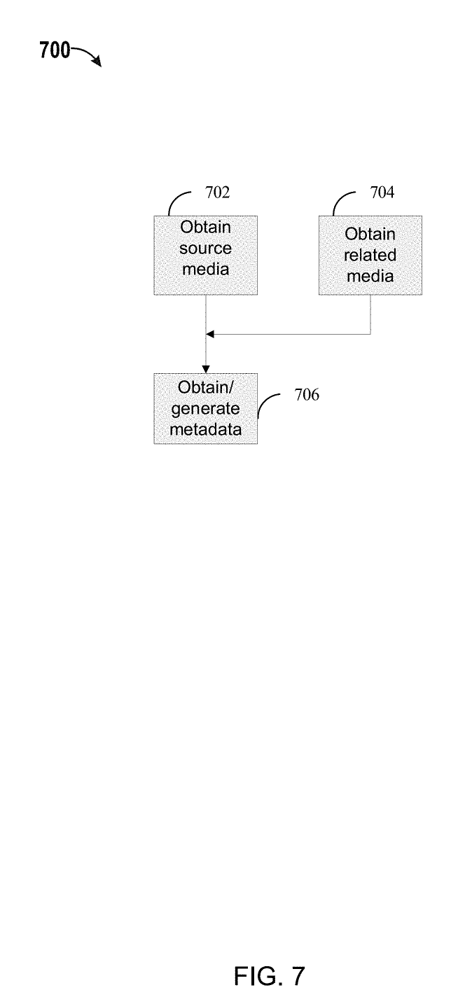

FIG. 7 depicts a flowchart for a method 700 of obtaining data in a system as shown in block 604 of FIG. 6, in accordance with an exemplary embodiment. As shown in method 700, the system (e.g., the I/O interfaces and devices 204 of FIG. 2) may obtain the source media file at block 702. The source media file may comprise a primary or main media file of an event. For example, the source media file may comprise the published media file for the event (e.g., as broadcast online or on television). At block 704, the system may obtain related media files. In some embodiments, the related media files may comprise alternate view or perspectives as compared to the source media file. For example, the source media file may include an audience view of an event and alternative perspectives or views may exist from each participant or player in the event. Accordingly, the system may obtain views from each participant or from various camera angles or cameras. At block 706, the system may obtain or generate metadata based on the source media file and/or the related media files. In some embodiments, the metadata may comprise any details regarding the views, perspectives, objects contained in the media files, etc. For example, the metadata may include one or more of a title, a description, a time the source media file was recorded, a language in which the source media file was recorded or dubbed, game information, tags, location information, creator, etc.

The layer for online discussion may identify and collect data from only comment or discussion forums or websites (or similar only sources). For example, the online discussion layer may include comments from Facebook, Twitter, reddit, YouTube, Twitch, and similar online discussion or social media forums. In some embodiments, the comments or posts may be from a livestream or livestream chat associated with the source media file or the event. The online discussion layer may identify comments from any of these or other forums based on identifying times for when the comments were posted in relation to the event occurring or the source media file of the event being available for viewing. For example, the online discussion layer may identify that the event (e.g., a gaming competition between two particular teams) began at 9 am and lasted until 11 am on Monday, September 4. The online discussion layer may then identify online discussion or social media forum posts associated with or relating to these teams (e.g., by looking at the discussion or social media pages associated with the teams). The online discussion layer may then isolate and “collect” comments or posts that were made between 9 am and 11 am or that reference any time between 9 am and 11 am on September 4. Accordingly, the online discussion layer is able to identify comments or posts that likely relate to the gaming competition between the two teams. Collecting may comprise identifying and/or saving the comments or posts as a reference source of data for use in analysis of the source media file, as will be described further herein. In some embodiments, the online discussion layer may identify one or more websites or forums to search for comments or posts based on an input form the user. In some embodiments, the one or more websites or forums may be predefined. For example, the online discussion layer may automatically search Reddit, Facebook, Twitter, and Twitch for comments or posts relating to a particular event or portion thereof. For example, each of these sites may provide for searching of posts or may provide a firehose of content. The firehose may be all public content that is being posted on the site. The firehose content may be searched or parsed based on tags or descriptions to identify any relevant content. For example, the firehose content of Facebook and Twitter may be parsed based on tags and descriptions such as “Video Game North American Playoffs Finals” or “Video Game finals” or player names to identify relevant content. Alternatively, or additionally, some online discussion content may be associated with a participant or a source media file itself (e.g., on Twitch). Thus, one or more of these search methods may be applied for the online discussion layer to identify comments or posts. Similar methods may be applied for the online media clip layer to identify media clips and the spectator media layer to identify spectator media.

Once the comments or posts are collected, the online discussion layer may then parse and/or otherwise analyze the comments and posts to identify: frequency or volume of comments or posts throughout the event or that reference particular moments or occurrences of the event, content in the comments or posts (e.g., emojis, “LOL”, emoji-like term such as “Pogchamp” or “Kappa”, etc.), and quality of the comments or posts. The online discussion layer may analyze the frequency or volume of comments or posts to identify occurrences in the source media file. For example, if the online discussion layer identifies 10 comments within 30 seconds of each other that each mention one or more of the terms “kill”, “shot”, or “score”, etc., then the online discussion layer may determine that one of the teams earned points for or accomplished a “kill” in the gaming competition corresponding to those comments. In some embodiments, the online media clips may be used to generate a rank as to how the kill (or other occurrence) ranks in relation to other occurrences (similar and different). Alternatively, or additionally, the online discussion layer may identify multiple comments that refer to a particular moment (e.g., “great kill at 10:15” or “Score @ 10:15”) and determine that one of the teams earned the points for or accomplished the “kill” corresponding to these comments. In some embodiments, the online discussion layer may identify sentiments or perceptions from the comments or posts. For example, the online discussion layer may identify emojis or other content conveying happiness or excitement and determine that these are associated with the “kills” and other scoring events. When the online discussion layer identifies that there are no posts or infrequent posts, then the online discussion layer may determine that no noteworthy events occur during these periods of the source media file.

In some embodiments, the online discussion layer may be used to identify and/or categorize moments in the source media file based on the comments and posts collected. The online discussion layer may generate a listing or database of moments with frequent keywords or terms based on the categorization, and the database or listing may be searched based on requested occurrences or occurrence types. For example, the online discussion layer may identify happy occurrences, sad occurrences, kill occurrences, scoring occurrences, etc. for viewing and/or searching by the user. In some embodiments, the online discussion layer may search the collected comments and posts only based on specific terms received from the user. For example, the online discussion layer may only search comments or posts from online forums based on a “kill” occurrence request from the user and may only return potential kill occurrences, ignoring all other comments or posts. Outputs may be generated by the online discussion layer based on either or both of these embodiments.

The online discussion layer may determine weights or qualities of comments or posts or of identified occurrences. For example, comments or posts by verified users on particular forums (e.g., comments or posts by one of the teams or a team representative) may be given higher weight than comments from a first time poster on the forum. For example, a comment by the team representative to “check out the kill @ 10:45” may be given greater weight than a similar comment posted at the same time or with the same content by a first time poster to the forum. Additionally, or alternatively, uniqueness of the comment(s) may impact weight attributed to the comment. For example, 5 posts from 1 person identifying an occurrence may have a lower weight than 1 post from each of 5 people identifying the occurrence. Additionally, the comments or posts may be given different weights based on the forum sources. For example, a comment or post on Twitch or Facebook may be given higher weight than a comment or post on Twitter. Additionally, feedback the comments or posts receive may also be used to weight the comment or post. For example, a comment or post with 10 “Likes” on Facebook may have higher weight than a comment or post with 2 “Likes”.

In some embodiments, the online discussion layer may assign confidence values for identified clips or portions or moments. For example, if the online discussion layer identifies an occurrence or moment based on two posts by team representatives, the occurrence may have a confidence score of 100%. However, if the occurrence is identified based on 10 posts from 10 new members of the forum, then the confidence score for the occurrence may be 50%. Thus, confidence scores may be impacted by the source of the comments, the quantity of the comments, or any other weighting factors. In some embodiments, only occurrences having threshold or greater confidence scores will be output.

Once the online discussion layer identifies occurrences, the systems and methods must synchronize the timeline of the source media file with timelines/timestamps of the comments or posts and occurrences identified based thereon. For example, the comments or posts may reference a time of 10:15 but it may not be clear if that means a 10:15 mark in the source media or 10:15 AM on September 4. Additionally, the comments or posts that are identified as being posted at a particular time on the forum (e.g., 15 comments posted within 30 seconds of 11 AM forum time) may be synchronized with 11 AM of the source media file. The systems and methods may identify offsets between the forum clock and the “in game” clock or the media source clock (e.g., the recording device clock) and use the offsets to synchronize the comments or posts with corresponding moments or occurrences in the source media file. In some embodiments, synchronization may be performed based on identifying occurrences across comments. For example, an occurrence identified in the comments may occur at a known time and, thus, an offset between the known time and the identified comments may be used to synchronize. In some embodiments, a timestamp for when the comments or posts were captured by the systems or methods is compared with the forum's timestamp and the media source timestamp. The systems or methods may then identify differences between the system timestamp, the forum timestamp, and the media source timestamp. By comparing the timestamps, the offsets may be identified, and the offsets can be used with the timestamps of the comments, etc., to identify corresponding occurrence times in the media source to synchronize the comments or posts with the source media file. In some embodiments, chats that occur in the source media file can be used for synchronization of the comments or posts with the source media file.

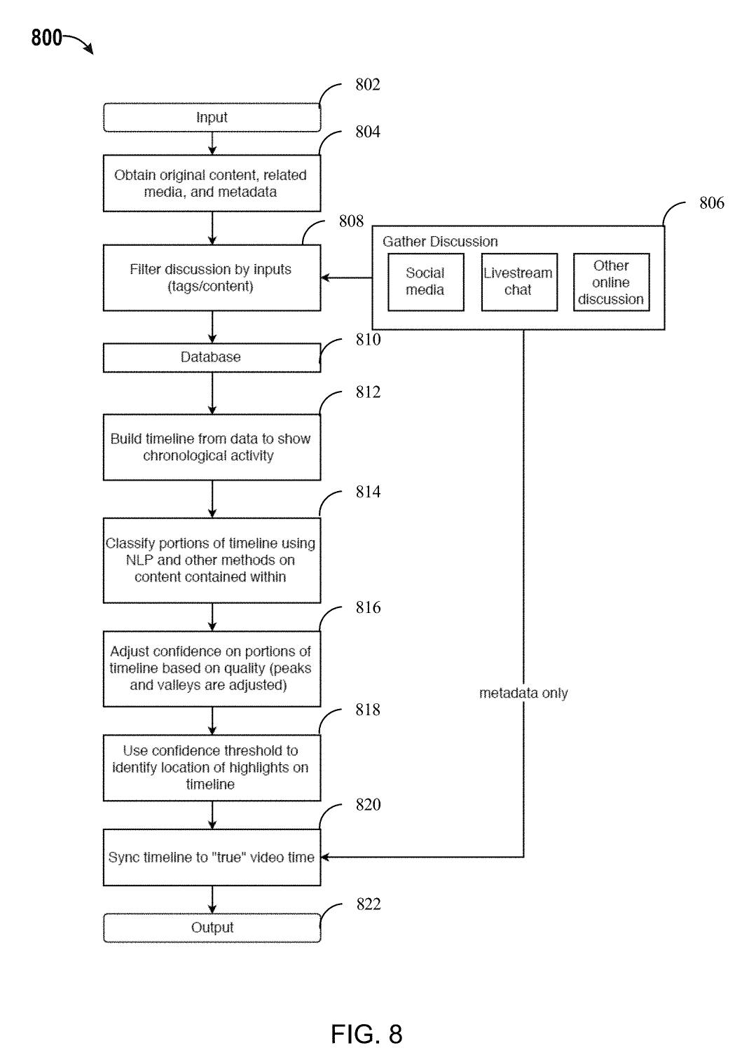

FIG. 8 depicts a diagram 800 of a system and corresponding inputs, processes, and outputs for identifying, categorizing, and/or describing occurrences in a source media file of an event based on online discussion comments or posts, in accordance with an exemplary embodiment. The diagram 800 may be a more specific implementation of the method 300 of FIG. 3. In some embodiments, the different blocks of the diagram 800 may represent or be performed by components of the device 200. The diagram 800 includes an input block 802 for the system. In some embodiments, input block 802 may correspond to one or more of the I/O interfaces and devices 204 or the user interface module 220 of FIG. 2. The input block 802 may provide for the receiving of information used by the system to identify, categorize, and describe the occurrences. The input block 802 may allow the system to obtain the source media file, related media files (such as alternative perspectives or camera angles, additional content, behind the scenes views, other video of the same event as the source media file (such as audience view)), and metadata at block 804. In some embodiments, the input block 802 may also provide for input of user inputs (not shown). In some embodiments, the system will determine the metadata based on the obtained source media file and related media files.

At block 806, the system may obtain online discussion comments or posts. In some embodiments, the online discussion comments or posts may be obtained and processed by the online discussion layer. In some embodiments, the online discussion comments may be obtained from social media, a livestream chat, or other online discussion forums. In some embodiments, the system (e.g., the online discussion layer) may obtain or generate metadata based on the collected comments or posts. In some embodiments, the collected comments or posts may be used in block 808 and the metadata may be used in block 820. At block 808, the system or the online discussion layer may filter the obtained comments or posts based on inputs received from the user. For example, if the user requests goals or scoring occurrences, then the system or online discussion layer may filter the comments or posts based on those relating to goals or scoring occurrences. This may reduce a number of comments or posts to consider when trying to identify the desired occurrences. The filtered comments or posts may be stored in a database (corresponding to the mass storage device 210 or the memory 206 or an external storage) at block 810.

At block 812, the system or the online discussion layer may build a timeline from data to show chronological activity. In some embodiments, the timeline may be built from timestamps and similar information of the forum from which the comments or posts were obtained. Thus, the timeline may comprise all the occurrences that were identified based on the comments and posts from the forums. In some embodiments, metadata of the comments or posts may be used to build the timeline (not shown). In some embodiments, a timeline may also be built for the source media file. At block 814, the system or the online discussion layer may tag or classify portions of the timeline using NLP and other methods on content contained within (e.g., player name, whether occurrence was a kill or other death, whether occurrence was funny or sad, etc.). At block 816, the system or the online discussion layer may adjust confidence in portions of the timeline based on quality (peaks and valleys are adjusted). This may relate to adjusting confidence based on source (e.g., if all comments are by a single entity, then confidence may be reduced, thus adjusting a peak “down”). The adjustment may also be made based on uniqueness, trustworthiness, social proof (e.g., likes, views, etc.). Accordingly, the threshold may be adjusted based on analysis of the content and data. At block 818, the system or the online discussion layer applies a confidence threshold to identify locations of occurrences (e.g., highlights) on the generated timeline. In some embodiments, the confidence threshold value may be preset or may be received from the user input. In some embodiments, the confidence threshold may be dynamic based on the weights and/or qualities of the forums of the comments and posts. Alternatively, or additionally, the threshold may remain relatively static but content may be removed based on analysis of the content and data. At block 820, the system or the online discussion layer synchronizes the timeline of the identified occurrences with the timeline of the source media file. This may involve correcting for or applying identified offsets, as described herein. In some embodiments, the metadata from the online discussion layer may be used to synchronize the timelines or to identify the offset between the timelines. The synchronized occurrences may then be output to a display or for storage in a database.

The layer for online media clips may identify and collect data from only comments or posts that include media clips, regardless of the forum on which the comments or posts are made. For example, the online media clips layer may include videos or other media posted on Facebook, Twitter, reddit, YouTube, Twitch, and similar online discussion or social media forums. The online media clips layer may identify media clips in comments from any of these or other forums based on identifying times for when the comments were posted. For example, the online media clips layer may identify that the event (e.g., a gaming competition between two particular teams) began at 9 am and lasted until 11 am on Monday, September 4. The online media clips layer may then identify online discussion or social media forum posts including media clips associated with or relating to these teams (e.g., by looking at the discussion or social media pages associated with the teams) or that include clips of the source media file. The online media clips layer may then isolate and “collect” comments or posts including media that were made between 9 am and 11 am or that reference any time between 9 am and 11 am on September 4. Accordingly, the online media clips layer is able to identify comments or posts with media clips that likely relate to the gaming competition between the two teams. Collecting may comprise identifying and/or saving the comments or posts with media clips as a reference source of data for use in analysis of the source media file, as will be described further herein. As noted above, the online media clip layer may identify one or more websites or forums to search for media clips based on an input from the user. In some embodiments, the one or more websites or forums may be predefined. For example, the online media clip layer may automatically search Reddit, Facebook, Twitter, and Twitch for comments or posts relating to a particular event or portion thereof. For example, each of these sites may provide for searching of posts or may provide a firehose of content. The firehose may be all public content that is being posted on the site. The firehose content may be searched or parsed based on tags or descriptions to identify any relevant content. For example, the firehose content of Facebook and Twitter may be parsed based on tags and descriptions such as “Video Game North American Playoffs Finals” or “Video Game finals” or player names to identify relevant content. Alternatively, or additionally, some online media clip content may be associated with a participant or a source media file itself (e.g., on Twitch). Thus, one or more of these search methods may be applied for the online media clip layer to identify comments or posts. Similar methods may be applied for other layers.

Once the comments or posts with media clips are collected, the online media clips layer may then parse and/or otherwise analyze the media clips of the comments or posts to identify: metadata of the media clips, frequency or volume of comments or posts throughout the event or that include media clips of particular moments or occurrences of the event, content in the media clips (e.g., particular moments captured in the media clips, etc.), and quality of the comments or posts and/or media clips. The online media clips layer may analyze the frequency or volume of comments or posts with media clips to identify occurrences in the source media file. For example, if the online media clips layer identifies 10 comments within 30 seconds of each other that each include media clips of a time when the team earns points, then the online media clips layer may determine that one of the teams earned points for or accomplished a “kill” in the gaming competition corresponding to those media clips at a particular time shown in the media clips. In some embodiments, the online media clips layer may identify sentiments or perceptions from the media clips included in the comments or posts. For example, the online media clips layer may identify emotions in the media clips included in the comments or posts. The emotions may be identified based on language used, or sounds/exclamations heard, faces seen, etc. When the online media clips layer identifies that there are no posts or infrequent posts that include media clips of particular moments in the source media file, then the online media clips layer may determine that no noteworthy events occur during these periods of the source media file.

In some embodiments, the online media clips layer may identify metadata in the media clips of the comments or posts. This metadata may include timestamp information, location information, tags, and/or descriptions. In some embodiments, the online media clips layer may use the metadata to help synchronize the occurrences in the media clips with the source media file. For example, clips may have a comment identifying the occurrence (e.g., “Check out this clip of Bob getting a double kill vs. Red Team”). In some embodiments, the metadata may be used for filtering. For example, the metadata may be used to identify whether a media clip is relevant (e.g., allow for excluding clips with tags such as “cute baby” vs. “Game Finals”).

In some embodiments, the online media clips layer may be used to identify and/or categorize moments in the source media file based on the media clips of the comments and posts collected. The online media clips layer may generate a listing or database of moments with frequent keywords or terms based on the categorization, and the database or listing may be searched based on requested occurrences or occurrence types. For example, the online media clips layer may identify happy occurrences, sad occurrences, kill occurrences, scoring occurrences, etc. for viewing and/or searching by the user. In some embodiments, the online media clips layer may search the collected media clips of the comments and posts only based on specific terms received from the user. For example, the online media clips layer may only search media clips of the comments or posts from online forums based on a “kill” occurrence request from the user and may only return potential kill occurrences, ignoring all other media clips in other comments or posts. Outputs may be generated by the online media clips layer based on either or both of these embodiments.

The online media clips layer may determine weights or qualities of media clips in the comments or posts or of identified occurrences. For example, the media clips in the comments or posts by verified users on particular forums (e.g., comments or posts by one of the teams or a team representative) may be given higher weight than media clips in comments from a first time poster on the forum. For example, a media clip in a comment by the team representative capturing a period of 15 seconds may be given greater weight than a similar media clip in the comment posted at the same time or with the same content by a first time poster to the forum. Additionally, or alternatively, uniqueness of the media clips in the comment(s) may impact weight attributed to the media clip comment. For example, 5 media clips from 1 person identifying an occurrence may have a lower weight than 1 media clip from each of 5 people identifying the occurrence. Additionally, the comments or posts may be given different weights based on the forum sources. For example, a media clip included in a comment or post on Twitch or Facebook may be given higher weight than a media clip posted in a comment or post on Twitter. Additionally, feedback of the media clips in the comments or posts may also be used to weight the comment or post. For example, a media clip in a comment or post with 10 “Likes” on Facebook may have higher weight than a media clip in a comment or post with 2 “Likes”.

In some embodiments, the online media clips layer may assign confidence values for identified clips or portions or moments. For example, if the online media clips layer identifies an occurrence or moment based on two posts by team representatives, the occurrence may have a confidence score of 100%. However, if the occurrence is identified based on 10 posts from 10 new members of the forum, then the confidence score for the occurrence may be 50%. Thus, confidence scores may be impacted by the source of the comments with media clips, the quantity of the comments with media clips, or any other weighting factors. In some embodiments, only occurrences having threshold or greater confidence scores will be output.

Once the online media clips layer identifies occurrences, the systems and methods must synchronize the timeline of the source media file with timelines/timestamps of the comments or posts having media clips and occurrences identified based thereon. For example, the comments or posts with a greater number of media clips including the same portions or clips of the source media file may reference a time of 10:15 but it may not be clear if that means a 10:15 mark in the source media or 10:15 AM on September 4. Additionally, the comments or posts that are identified as being posted at a particular time on the forum (e.g., 15 comments posted within 30 seconds of 11 AM forum time) may be synchronized with 11 AM of the source media file. The systems and methods may identify offsets between the forum clock and the “in game” clock or the media source clock (e.g., the recording device clock) and use the offsets to synchronize the comments or posts having media clips with corresponding moments or occurrences in the source media file. In some embodiments, synchronization may be performed based on identifying occurrences across media files. For example, an occurrence identified in the media files may occur at a known time and, thus, an offset between the known time and the identified media file may be used to synchronize. In some embodiments, a timestamp for when the comments or posts were captured by the systems or methods is compared with the forum's timestamp and the media source timestamp. The systems or methods may then identify differences between the system timestamp, the forum timestamp, and the media source timestamp. By comparing the timestamps, the offsets may be identified, and the offsets can be used with the timestamps of the comments, etc., to identify corresponding occurrence times in the media source to synchronize the comments or posts with the source media file. In some embodiments, chats that occur in the source media file can be used for synchronization of the comments or posts with the source media file. In some embodiments, the media clips in the comments or posts may be analyzed with the source media clips to identify the portions of the source media clips saved in the media clips of the comments.

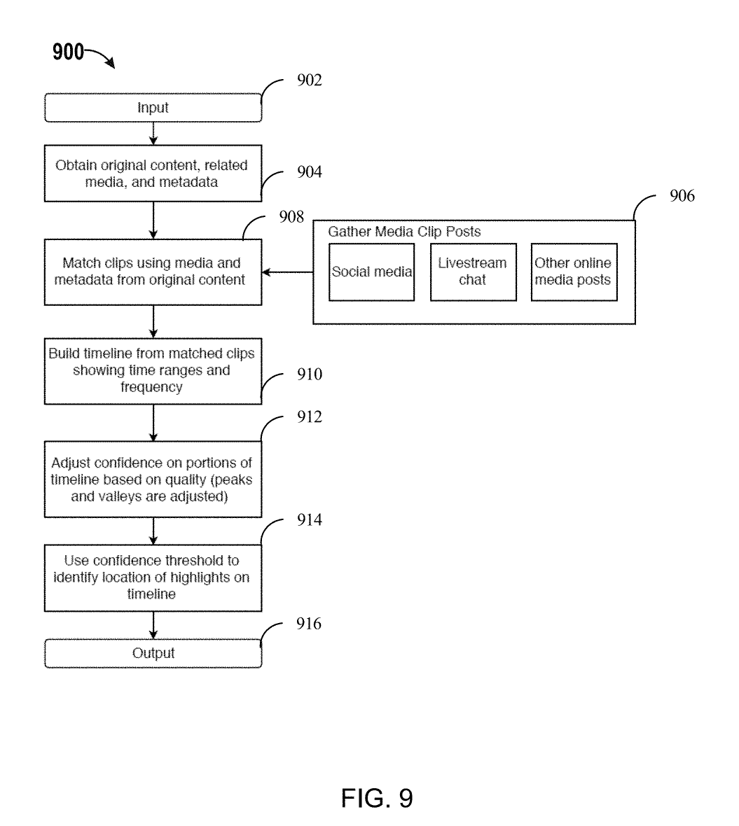

FIG. 9 depicts a diagram 900 of a system and corresponding inputs, processes, and outputs for identifying, categorizing, and/or describing occurrences in a source media file of an event based on media clip posts, in accordance with an exemplary embodiment. The diagram 900 may be a more specific implementation of the method 300 of FIG. 3. In some embodiments, the different blocks of the diagram 900 may represent or be performed by components of the device 200. The diagram 900 includes an input block 902 for the system. In some embodiments, input block 902 may correspond to one or more of the I/O interfaces and devices 204 or the user interface module 220 of FIG. 2. The input block 902 may provide for the receiving of information used by the system to identify, categorize, and describe the occurrences. The input block 902 may allow the system to obtain the source media file, related media files (such as alternative perspectives or camera angles, additional content, behind the scenes views, other video of the same event as the source media file (such as audience view)), and metadata at block 904. In some embodiments, the input block 902 may also provide for input of user inputs (not shown). In some embodiments, the system will determine the metadata based on the obtained source media file and related media files.

At block 906, the system may obtain media clips from online discussion comments or posts. In some embodiments, the media clips may be obtained and processed by the online media clip layer. In some embodiments, the media clips may be obtained from social media posts, livestream chat posts, or other online discussion forum posts. In some embodiments, the system (e.g., the online media clip layer) may obtain or generate metadata based on the collected media clips or corresponding comments or posts. In some embodiments, the collected media clips may be used in block 908. At block 908, the system or the online media clip layer may the collected clips with corresponding portions in the source media file. In some embodiments, such matching may utilize metadata from one or both of the source media file and the media clips. Accordingly, matching the media clips with the source media file may essentially operate to identify the occurrences from the media clips in the source media file.

At block 910, the system or the online media clip layer may build a timeline from the matched clips, the timeline showing time ranges of the media clips and a frequency of the media clips. This information may be useful in showing the quality or weight of each occurrence and also help better identify each occurrence. At block 912, the system or the online media clip layer may adjust confidence of portions of the timeline based on weights or quality, as described herein. Accordingly, some of the occurrences in the timeline may be removed while others are maintained or weighted more highly. In some embodiments, a portion or clip may be weighted differently to adjust confidence values as opposed to being removed. For example, a clip (from seconds 20-35) may be weighed down to near zero, which may reduce all confidence values along the timeline in the 20-35 second range. At block 914, the system or the online media clip layer may use a confidence threshold to identify locations of occurrences (e.g., highlights) on the generated timeline. In some embodiments, the confidence threshold value may be preset or may be received from the user input. In some embodiments, the confidence threshold may be dynamic based on the weights and/or qualities of the forums of the comments and posts. At block 916, the system or the online media clip layer outputs the occurrences or highlights to a display or for storage in a database.

The layer for spectator media or reaction may identify and collect data from media including spectators or reactions of the spectators of the event. For example, the spectator media layer may collect videos or other media posted on various online discussion or social media forums that show or provide spectators' reactions to the event. In some embodiments, the spectators' reactions may be in response to the original event itself or to recordings or livestreams of the event. The spectator media layer may identify sentiment data based on analysis of the spectator media. For example, the spectator media layer may analyze facial expressions in video clips or images of spectators to identify sentiment or perceptions at a particular moment. Alternatively, or additionally, the spectator media layer may identify people clapping in the media to identify applause to identify completion of a moment or a spectator crying or observing “wide-eyed” in surprise or amazement.

The spectator media layer may identify spectator media in comments or independent posting from forums based on identifying times for when the spectator media was posted. For example, the spectator media layer may identify that the event (e.g., a gaming competition between two particular teams) began at 9 am and lasted until 11 am on Monday, September 4. The spectator media layer may then identify spectator media posts in forums including media associated with or relating to these spectator observing the gaming competition (e.g., either live or via a recording). The spectator media layer may then isolate and “collect” spectator media posts that were made between 9 am and 11 am or that reference any time between 9 am and 11 am on September 4. Accordingly, the spectator media layer is able to identify spectator media that likely relate to the gaming competition between the two teams. Collecting may comprise identifying and/or saving the spectator media as a reference source of data for use in analysis of the source media file, as will be described further herein. In some embodiments, the spectator media layer may identify one or more websites or forums to search for spectator media based on an input form the user. In some embodiments, the one or more websites or forums may be predefined. For example, the spectator media layer may automatically search Reddit, Facebook, Twitter, and Twitch for spectator media relating to a particular event or portion thereof. For example, each of these sites may provide for searching of media or may provide a firehose of content. The firehose may be all public content that is being posted on the site. The firehose content may be searched or parsed based on tags or descriptions to identify any relevant content. For example, the firehose content of Facebook and Twitter may be parsed based on tags and descriptions such as “Video Game North American Playoffs Finals” or “Video Game finals” or player names to identify relevant content. Alternatively, or additionally, some spectator media content may be associated with a participant or a source media file itself (e.g., on Twitch). Thus, one or more of these search methods may be applied for the spectator media layer to identify spectator media. Similar methods may be applied for other layers. In some embodiments, time associations may not be important for excluding spectator media, as spectator media may not be created during the event or at any particular time in relation to the event. Additionally, or alternatively, spectator media may be created or obtained locally (e.g., from a local audience that is monitored for expressions and speech during the event). Such spectator media may be used to construct a timeline based on the local audience. In some embodiments, regardless of the media type (e.g., video, audio, virtual reality, augmented reality, etc.), the spectator media layer may analyze the spectator media to identify occurrences or types of occurrences based on the spectators in the media (e.g., laughing, yelling, volume of spectators, cheering, etc.).

Once the spectator media are collected, the spectator media layer may then parse and/or otherwise analyze the spectator media to identify: metadata of the media clips, frequency or volume of media clips throughout the event, sentiment or perception identified in the media clips (e.g., sadness, happiness, surprise, etc.), and quality of the spectator media. The spectator media layer may analyze the frequency or volume of spectator media to identify occurrences in the source media file. For example, if the spectator media layer identifies 10 spectator media clips each covering the same 30 seconds that each include reactions to the team earning points, then the spectator media layer may determine that one of the teams earned points for or accomplished a “kill” in the gaming competition corresponding to those spectator media at a particular time. In some embodiments, the spectator media may be analyzed to identify occurrences in the spectator media. Some spectator media may be a full length of the event or include reactions to multiple occurrences in the event instead of being divided into particular occurrences. Thus, the spectator media may be analyzed to identify individual reactions in the spectator media and may work to synchronize particular reactions with occurrences as opposed to just synchronizing the spectator media with occurrences. In some embodiments, the spectator media layer may identify sentiments or perceptions from the spectator media. For example, the spectator media layer may identify emotions in the media clips included in the comments or posts. The emotions or sentiment may be identified based on language used, or sounds/exclamations heard, faces seen, etc. When the spectator media layer identifies that there is no spectator media or infrequent spectator media, then the spectator media layer may determine that no noteworthy events occur during these periods of the source media file.

In some embodiments, the spectator media layer may identify metadata in the spectator media clips. This metadata may include timestamp information, location information, tags, and/or descriptions. In some embodiments, the spectator media layer may use the metadata to help synchronize the occurrences in the media clips with the source media file. For example, spectator media may include a comment identifying the occurrence (e.g., “Check out this clip of Bob getting a double kill vs. Red Team”). In some embodiments, the metadata may be used for filtering. For example, the metadata may be used to identify whether a media clip is relevant (e.g., allow for excluding clips with tags such as “cute baby” vs. “Game Finals”).

In some embodiments, the spectator media layer may be used to identify and/or categorize moments in the source media file based on the spectator media. The spectator media layer may generate a listing or database of moments with frequent keywords or terms based on the categorization, and the database or listing may be searched based on requested occurrences or occurrence types. For example, the spectator media layer may identify happy occurrences, sad occurrences, kill occurrences, scoring occurrences, etc. for viewing and/or searching by the user. In some embodiments, the spectator media layer may search the collected spectator media only based on specific terms received from the user. For example, the spectator media layer may only search spectator media based on a “kill” occurrence request from the user and may only return potential kill occurrences, ignoring all other spectator media in other comments or posts. Outputs may be generated by the spectator media layer based on either or both of these embodiments.

The spectator media layer may determine weights or qualities of media clips or of identified occurrences. For example, the media clips including or by verified users on particular forums (e.g., comments or posts by one of the teams or a team representative) may be given higher weight than media clips by non-verified users. For example, a spectator media clip by the team representative capturing a period of 15 seconds where an audience is applauding may be given greater weight than a similar media clip in the comment posted at the same time or with the same content by a first time poster to the forum. Additionally, or alternatively, uniqueness of the spectator media may impact weight attributed to the spectator media. For example, 5 media clips from 1 spectator identifying an occurrence may have a lower weight than 1 media clip from each of 5 spectators identifying the occurrence. Additionally, the spectator media may be given different weights based on the forum sources. For example, the spectator media included in a comment or post on Twitch or Facebook may be given higher weight than the spectator media posted in a comment or post on Twitter. Additionally, feedback of the spectator media may also be used to weight the comment or post. For example, a spectator media clip with 10 “Likes” on Facebook may have higher weight than a spectator media clip with 2 “Likes”.

In some embodiments, the spectator media layer may assign confidence values for identified clips or portions or moments. For example, if the spectator media layer identifies an occurrence or moment based on two posts by team representatives, the occurrence may have a confidence score of 100%. However, if the occurrence is identified based on 10 posts from 10 new members of the forum, then the confidence score for the occurrence may be 50%. Thus, confidence scores may be impacted by the source of the spectator media, the quantity of the spectator media, or any other weighting factors. In some embodiments, only occurrences having threshold or greater confidence scores will be output.

Once the spectator media layer identifies occurrences, the systems and methods must synchronize the timeline of the source media file with timelines/timestamps of the spectator media and occurrences identified based thereon. For example, the spectator media may reference a time of 10:15 but it may not be clear if that means a 10:15 mark in the source media or 10:15 AM on September 4. Additionally, the spectator media that are identified as being posted at a particular time on the forum (e.g., 15 spectator media posted within 30 seconds of 11 AM forum time) may be synchronized with 11 AM of the source media file. The systems and methods may identify offsets between the forum clock and the “in game” clock or the media source clock (e.g., the recording device clock) and use the offsets to synchronize the spectator media with corresponding moments or occurrences in the source media file. In some embodiments, synchronization may be performed based on identifying occurrences across spectator media. For example, an occurrence identified in the spectator media may occur at a known time and, thus, an offset between the known time and the identified spectator media may be used to synchronize. In some embodiments, the spectator media may include portions of the event (e.g., a portion of the audio of the event in the background during the spectator media) that may be used to synchronize the spectator media with the source media file based on an analysis or scraping of the spectator media. In some embodiments, a timestamp for when the spectator media were captured by the systems or methods is compared with the forum's timestamp and the media source timestamp. The systems or methods may then identify differences between the system timestamp, the forum timestamp, and the media source timestamp. By comparing the timestamps, the offsets may be identified, and the offsets can be used with the timestamps of the comments, etc., to identify corresponding occurrence times in the media source to synchronize the spectator media with the source media file. In some embodiments, chats that occur in the source media file can be used for synchronization of the comments or posts with the source media file. In some embodiments, the spectator media clips may be analyzed with the source media clips to identify the portions of the source media clips references in the spectator media.

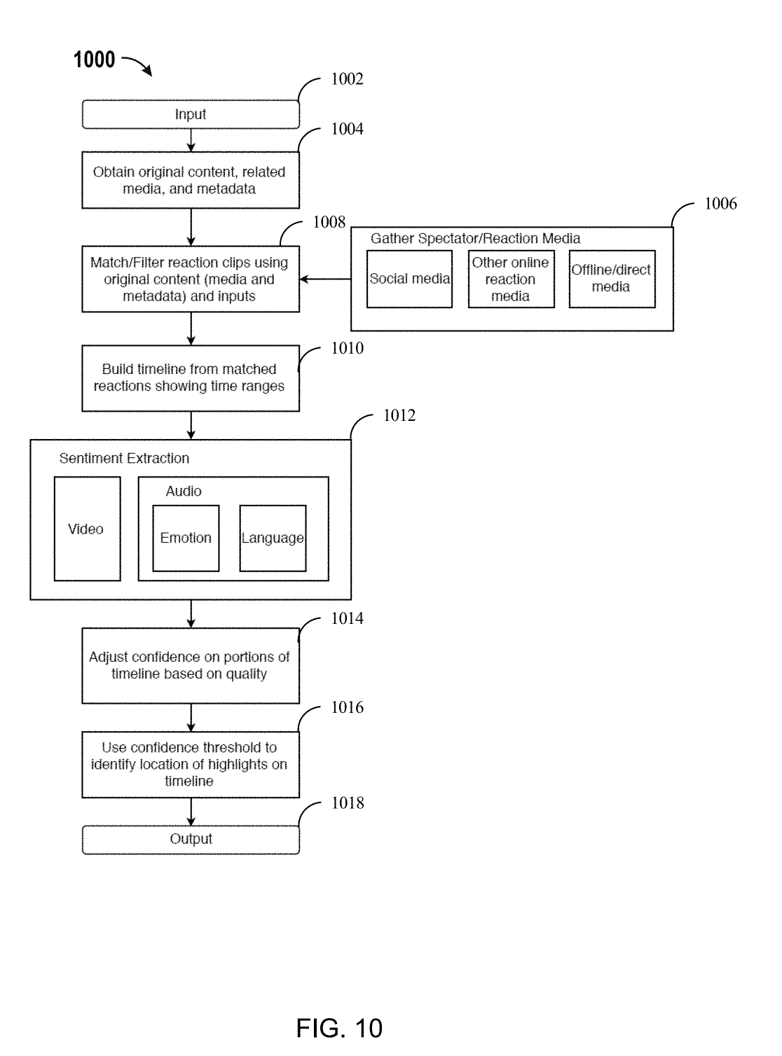

FIG. 10 depicts a diagram 1000 of a system and corresponding inputs, processes, and outputs for identifying, categorizing, and/or describing occurrences in a source media file of an event based on spectator or reaction media, in accordance with an exemplary embodiment. The diagram 1000 may be a more specific implementation of the method 300 of FIG. 3. In some embodiments, the different blocks of the diagram 1000 may represent or be performed by components of the device 200. The diagram 1000 includes an input block 1002 for the system. In some embodiments, input block 1002 may correspond to one or more of the I/O interfaces and devices 204 or the user interface module 220 of FIG. 2. The input block 1002 may provide for the receiving of information used by the system to identify, categorize, and describe the occurrences. The input block 1002 may allow the system to obtain the source media file, related media files (such as alternative perspectives or camera angles, additional content, behind the scenes views, other video of the same event as the source media file (such as audience view)), and metadata at block 1004. In some embodiments, the input block 1002 may also provide for input of user inputs (not shown). In some embodiments, the system will determine the metadata based on the obtained source media file and related media files.

At block 1006, the system may obtain spectator or reaction media. In some embodiments, the spectator media may be obtained and processed by the spectator media layer. In some embodiments, the spectator media may be obtained from social media, other online reaction media, or offline or direct media. At block 1008, the system or the spectator media layer may match or filter reaction clips using the source media file and the inputs received. In some embodiments, spectator media contains portions of the event as captured by the source media file. This portion of the event may be used to synchronize the timing between the spectator media and the source media file (as described herein). This portion may allow the spectator media layer to determine what occurrence the spectator is reacting to. Inputs may be used to identify biases and to exclude use of a spectator media in identifying occurrences for other non-biased or reversely biases users. For example, spectator media generated by a user that supports Blue Team may not be used (or may be given a low confidence level or low weight) when identifying occurrences for someone supporting the Red Team when Red Team occurrences are requested. For example, the spectator media layer may identify where the spectator media clips apply in relation to the timeline of the source media file to determine which spectator media apply to the source media file.

At block 1010, the system or the spectator media layer may build a timeline from the matched spectator media including time ranges of the spectator media. Thus, the timeline may comprise all the occurrences that were identified based on the spectator media. At block 1012, the system or the spectator media layer may extract sentiment or perception from the spectator media. In some embodiments, commentators/announcers may describe occurrences of the event as they happen. For example, one or both of the video and audio of the spectator media clips may be analyzed for sentiment. The video may be scanned, scraped, and otherwise analyzed to identify emotions or sentiments based on reactions or expressions being made by the spectator(s) in the media clip. Alternatively, or additionally, the audio of the media clip may be analyzed for emotional or emotive sounds or particular words used. For example, video of a spectator crying may be interpreted as being related to a saddening occurrence while audio of laughter may indicate a funny occurrence. At block 1014, the system or the spectator media layer may adjust confidence of portions of the timeline based on weights or quality. Accordingly, some of the occurrences in the timeline may be removed while others are maintained or weighted more highly. In some embodiments, a portion or clip of spectator media may be weighted differently to adjust confidence values as opposed to being removed. For example, a clip (from seconds 20-35) may be weighed down to near zero, which may reduce all confidence values along the timeline in the 20-35 second range. At block 1016, the system or the spectator media layer applies a confidence threshold to identify locations of occurrences (e.g., highlights) on the generated timeline. At block 1018, the system or the spectator media layer may output the highlights and identified occurrences to a display or for storage in a database.

The layer for source material may identify and collect data from or as provided by the source. For example, the source material layer may identify and/or collect data that is provided by the source of the source media file. For example, when the source media file is a livestream or recording of a gaming competition, the source material may include data or material that is obtained directly from the game. For example, this may include scores or score tracker information, logs (diagnostic or otherwise), or other data that is provided by the game. In some embodiments, the data may include details on statistics for players or teams in the game, scores, objects in the game (e.g., characters, objects being manipulated, etc.), and events occurring in the game. This data may not generally be visible to users but may be available as part of the source media file. The source material layer may identify this data and use it to identify occurrences in source media file. Generally, synchronization between the source material and the source media file may involve identifying in-game timestamps or events from the source media file and synchronizing to events identified in the source material using game times available in the logs (e.g., diagnostic or other). In some embodiments, the source material may be used by the source material layer to filter events (e.g., identify events for a particular team or user or to filter only particular events, etc.).

Once the source material is obtained or received, the source material layer may then parse and/or otherwise analyze the data to identify occurrences. The source material layer may analyze the data to identify occurrences in the source media file. For example, the source material may indicate score increases and actual events (e.g., character deaths, character score changes, etc.). Accordingly, the source material may be used to identify occurrences that are tracked by the game or source itself.

In some embodiments, the source material layer may be used to identify and/or categorize moments or occurrences in the source media file. The source material layer may generate a listing or database of moments with frequent keywords or terms based on the categorization, and the database or listing may be searched based on requested occurrences or occurrence types. For example, the source material layer may identify kill occurrences, scoring occurrences, etc. for viewing and/or searching by the user. In some embodiments, the source material layer may search the collected data only based on specific terms received from the user. For example, the source material layer may only search data based on a “kill” occurrence request from the user and may only return kill occurrences, ignoring all other occurrences. Outputs may be generated by the source material layer accordingly.

Since all data handled by the source material layer is from the source itself, the data or occurrences determined based on the data may all be weighted the same. Similarly, these occurrences may have high confidence levels as they are determined on information received from the source itself. In some embodiments, the confidence level is calculated differently than the confidence for the online discussion layer. For the source material layer, confidence may be assigned based on occurrences in the event. For example, a single kill may be worth 3 “points”, a triple kill 15 points, and a game win 50 points. Confidence may be best tied to these occurrences based on the material or data available, where more material may be provided where the game ends or more complicated occurrences happen. Since the quality of the information from the source is constant, there may not be any adjustment of the confidence level. The confidence range may be defined between the highest point occurrence (e.g., game end) being set to “1.0” and no occurrence being set to “0” with everything else dispersed within the range. In some embodiments, any of the other layers may calculate confidence as described herein.

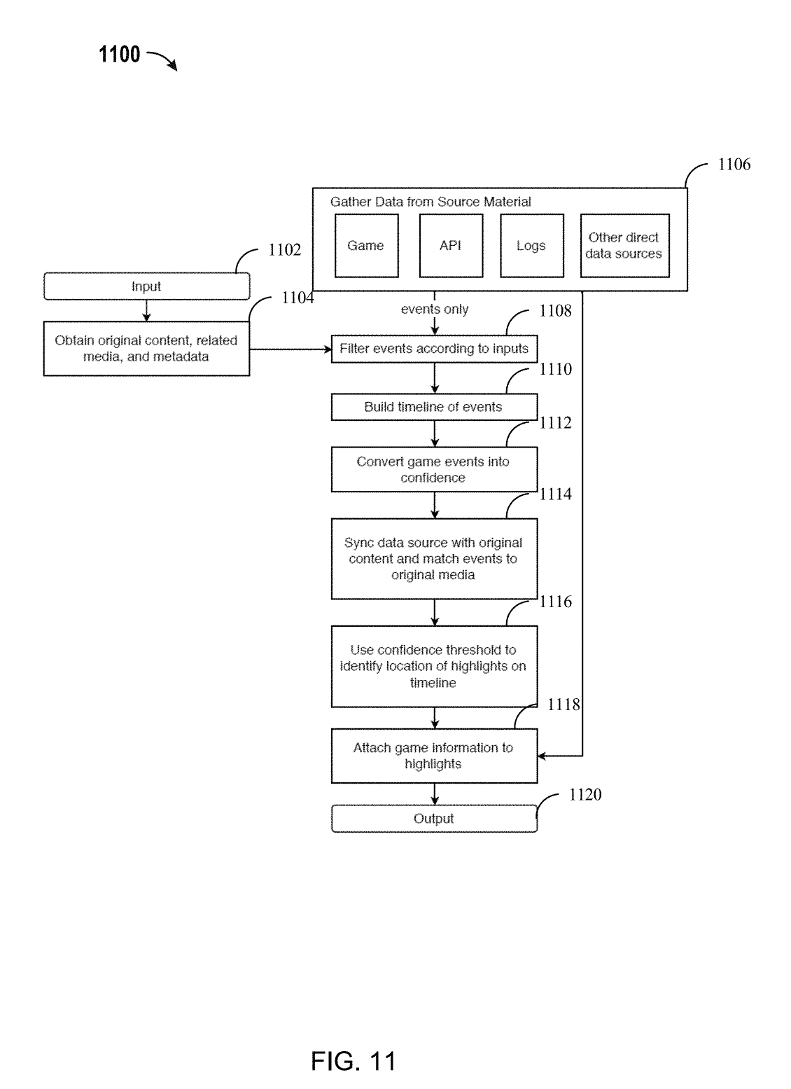

FIG. 11 depicts a diagram 1100 of a system and corresponding inputs, processes, and outputs for identifying, categorizing, and/or describing occurrences in a source media file of an event based on data received from the source itself, in accordance with an exemplary embodiment. The diagram 1100 may be a more specific implementation of the method 300 of FIG. 3. In some embodiments, the different blocks of the diagram 1100 may represent or be performed by components of the device 200. The diagram 1100 includes an input block 1102 for the system. In some embodiments, input block 802 may correspond to one or more of the I/O interfaces and devices 204 or the user interface module 220 of FIG. 2. The input block 1102 may provide for the receiving of information used by the system to identify, categorize, and describe the occurrences. The input block 1102 may allow the system to obtain the source media file, related media files (such as alternative perspectives or camera angles, additional content, behind the scenes views, other video of the same event as the source media file (such as audience view)), and metadata at block 1104. In some embodiments, the input block 1102 may also provide for input of user inputs (not shown). In some embodiments, the system will determine the metadata based on the obtained source media file and related media files.

At block 1106, the system may obtain or identify source material from the source (e.g., the system or game broadcasting the source media file) or from the source media file. In some embodiments, the source material may be obtained and processed by the source material layer. In some embodiments, the source material may be obtained from the game, an API, game logs, or other data sources, direct or indirect. In some embodiments, the system (e.g., the source material layer) may identify occurrences based on the data gathered at block 1106. These identified occurrences may be used in block 1108 and filtered according to the inputs received. At block 1108, the system or the source material layer may filter the obtained data and identified occurrences based on inputs received from the user and the input media files. For example, if the user requests goals or scoring occurrences, then the system or source material layer may filter the occurrences from block 1106 based on those relating to goals or scoring occurrences.

At block 1110, the system or the source material layer may build a timeline of occurrences based on the filtered occurrences. Thus, the timeline may comprise all the occurrences that were identified based on the data from the source(s) after filtering. At block 1112, the system or source material layer may convert identified occurrences into confidences or identify confidence levels corresponding with each identified occurrence. At block 1114, the system or the source material layer may synchronize the data from the source(s) with the source media file. Based on this synchronization, the identified occurrences can be synchronized with the source media file. At block 1116, based on the identified confidences for each identified occurrence, the system or the source material layer may identify locations of in the timeline or the source media file for each of the occurrences (e.g., identify where the occurrences occur in the source media file/timeline). At block 1118, game information may be attached to the occurrences to provide tags or description for the occurrences. The synchronized and tagged occurrences may then be output to a display or for storage in a database at block 1120.

The layer for source media data may identify and collect data from the source media file. For example, the source media data layer may analyze the video stream provided, specifically focusing on the image data and audio data provided in the source media file. In some embodiments, the source media file may comprise various components, including a screen as seen by competitors, competitor scores or parameter (e.g., health, weapons/ammo, etc.), alternate views or perspectives (e.g., red team vs. blue team views or perspectives), audience views (e.g., shots of the audience), etc. The source media data layer may monitor any changes in any views (images) or sounds to determine if any changes may indicate an occurrence. For example, if the video of the source media file switches perspective from watching the game screen to watching the audience, the source media data layer may determine this change indicates an occurrence in the game (e.g., a kill or score occurrence). Accordingly, the source media data layer may identify different views, perspective, and portions in the source media file and identify changes therebetween. Similarly, the source media data layer may determine that color changes in the video feed or zooming or changes or perspective indicate an occurrence. For example, changes in light levels or movement on the screen (from the participants' perspectives) may indicate an occurrence or accomplishment. Alternatively, or additionally, the source media data layer may identify game data that is part of the video or audio feed. For example, the scores for various players may be shown on the screen for a spectator to see. This information may be obtained by the source media data layer via a screen scraping process. Accordingly, the source media data layer may identify parameters of the game (e.g., game data, statistics for participants/characters, scores, elements of the game, characters, etc.) and determine occurrences accordingly (e.g., via text on screen regarding kill or scoring occurrence or comments from participants or spectators).

Similarly, the source media data layer may identify sentiment or perception based on video or audio from an audience or commentator. For example, screen scraping may be used to obtain facial expressions of the audience or commentator and this data may be analyzed to determine sentiment, emotions, or perceptions. Similarly, clapping, crying, etc. may be identified. Any of this information from the screen scraping may be used to identify occurrences or types of occurrences. Audio may be analyzed to track amplitude (e.g., loudness) of the audio and track any outbursts that may relate to an event (e.g., commentator becoming more excited as the occurrences that lead to the end of the event occur). Accordingly, speaking vs. yelling may be detected and analysis of the different moments may result in detecting of different occurrences. Additionally, many games have sound effects that may be used to indicate occurrences (e.g., death sounds, cheers or horns for accomplishments, etc.). An in-game announcer announcing scores or game events may also be analyzed to determine occurrences. The audio portion of the source media file (maybe separate from the video portion of the source media file) may be used to identify audio from a streamer/participant, an announcer, and the audience. For example, laughter from the audience combined with a sign or other negative sound from the streamer may indicate an occurrence involving the streamer that may have been negative for the streamer but enjoyable for the audience (e.g., a “fail” occurrence where the streamer fails to accomplish a goal to the amusement of the audience). The audio may also be analyzed for emotion/sentiment and language used. The audio may also provide identification of the occurrences directly (e.g., when the announcer announces an occurrence (e.g., kill, score, etc.).

The source media data layer may synchronize occurrences identified by using a game time. Additionally, the source media file and the related media file(s) may be synchronized. This may occur when the related media files are alternate views or perspectives. Synchronization may provide for synchronizing the perspectives so that the same occurrence(s) can be seen or viewed from the different perspectives. This synchronization may be performed based on occurrences in the media files (e.g., team members from the Blue Team speak to each other, allowing synchronization of the perspectives from the team members based on the speaking, etc.).

Since all data handled by the source media data layer is from the source itself, the data or occurrences determined based on the data may all have high confidence levels. However, different occurrences may have different weights (e.g., goals or kills may have higher weights than passes or assists).

In some embodiments, weights or confidences for any of the layers may be predetermined or set based on a preset scale. In some embodiments, the weights or confidences may be variable. In some embodiments, the user request may include an input of what layers or what parameters are to be given what weights. For example, in some embodiments, the user may indicate that the source media data layer is more highly weighted than the spectator media layer.

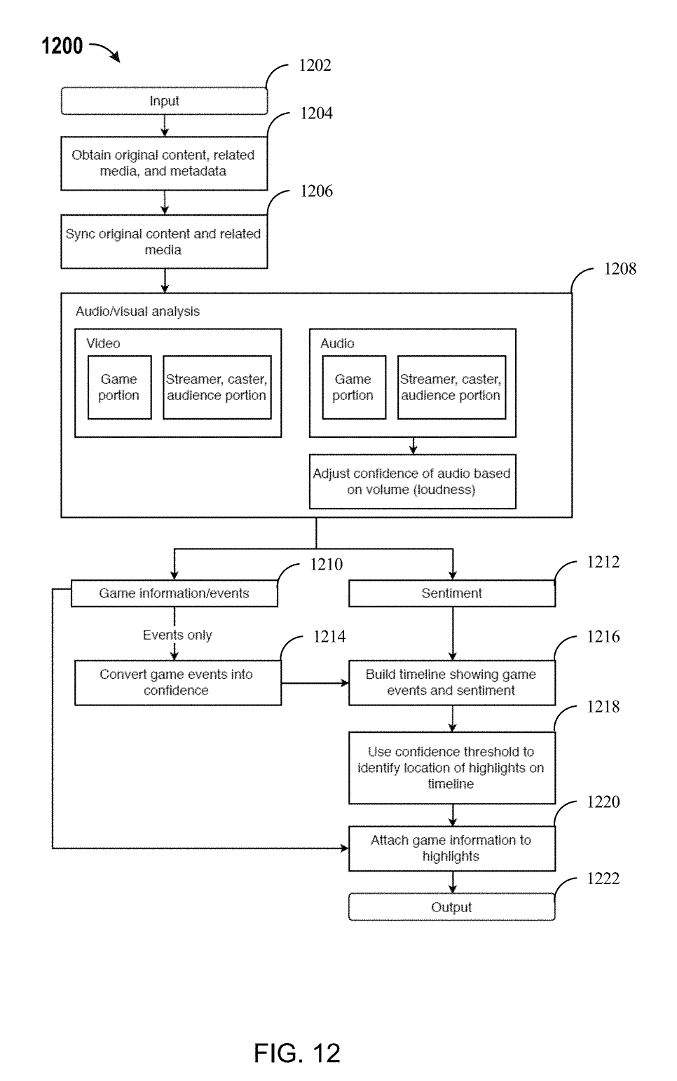

FIG. 12 depicts a diagram 1200 of a system and corresponding inputs, processes, and outputs for identifying, categorizing, and/or describing occurrences in a source media file of an event based on the source media file and related media files, in accordance with an exemplary embodiment. The diagram 1200 may be a more specific implementation of the method 300 of FIG. 3. In some embodiments, the different blocks of the diagram 1200 may represent or be performed by components of the device 200. The diagram 1200 includes an input block 1202 for the system. In some embodiments, the input block 1202 may correspond to one or more of the I/O interfaces and devices 204 or the user interface module 220 of FIG. 2. The input block 1202 may provide for the receiving of information used by the system to identify, categorize, and describe the occurrences. The input block 1202 may allow the system to obtain the source media file, related media files (such as alternative perspectives or camera angles, additional content, behind the scenes views, other video of the same event as the source media file (such as audience view)), and metadata at block 1204. In some embodiments, the input block 1202 may also provide for input of user inputs (not shown). In some embodiments, the system will determine the metadata based on the obtained source media file and related media files.

At block 1206, the system may synchronize the source media file and the related media file. The source media file and the related media file may be synchronized as described herein such that the information from the related media file is synchronized with the source media file. Accordingly, alternate view or perspectives may be synchronized.

At block 1208, the system or the source media file may perform audio /visual analysis on the source media file and the related media file. The analysis may analyze the video portions, which may include the game portion (e.g., the video that would be published or broadcast) and a participant (streamer)/announcer (caster)/audience portion, which may be video of another perspective of the events of the game portion. Similarly, audio from the game portions and the participant/announcer/audience portions may be analyzed. In some embodiments, the audio portion(s) may be analyzed to determine confidence levels of synchronization based on audio (e.g., volume or other metrics or parameters of the audio).

At block 1210, the system or source media data layer may identify game information and occurrences and convert the game occurrences into confidence measures at block 1214. Additionally, at block 1212, the system or source media data layer may determine or identify a sentiment based on the analyzed video and audio. The video and audio may be scanned, scraped, and otherwise analyzed to identify emotions or sentiments based on reactions or expressions identified in the source media file and/or the related media file(s). For example, video of a spectator crying may be interpreted as being related to a saddening occurrence while audio of laughter may indicate a funny occurrence. In some embodiments, the identified occurrence from the game information may be used to identify the occurrence and a corresponding tag or description. For example, the game data may provide that “Blue Team's Bob gets two kills in office.” A corresponding sentiment portion may include laughter from an audience at the corresponding moment, which may be used to indicate that the kill was humorous in some way (e.g., a “fail”). Thus, the sentiment may be used in combination with the occurrence as identified from the game information to tag or describe occurrences. At block 1216, the system or source media data layer may build a timeline based on the game events from block 1214 and the sentiment from block 1212. Thus, the timeline may comprise all the occurrences that were identified based on the analysis of the source media file and the related media file(s). In some embodiments, the built timeline may include time ranges for identified occurrences.

At block 1218, the system or the source media data layer applies a confidence threshold to identify locations of occurrences (e.g., highlights) on the generated timeline. As described herein, application of the confidence threshold may comprise determining whether the confidence level of each identified occurrence exceeds a threshold (as received as a user input or a preset threshold) such that only occurrences that are certain to a desired level are identified. At block 1220, the game information as identified at block 1210 is appended to the highlights, thus creating any tags or description related to the occurrences. At block 1222, the system or the source media data layer may output the highlights and identified occurrences to a display or for storage in a database.

The output information (e.g., the identified occurrences and corresponding information as described in relation to FIGS. 8-12) may be stored in a database (e.g., the mass storage media 210 or the memory 206). In some embodiments, the source media file, metadata derived from or based on the source media file, start and end timestamps for identified occurrences, descriptions of the identified occurrences (e.g., “ABC Bob (Cat) gets a quadra kill in blue base and Team ABC gets a total of 5 kills and wins the game.”), tags associated with the identified occurrences (e.g., “funny”, “quadra kill”), and a ranking of the identified occurrences may also be stored in the database. The information stored in the database may be used as described below.

A media player, as described herein, may take portions of different media clips and user perspectives and generate a single output media clip. In some embodiments, the media player be implemented by one or more components of the device 200 (e.g., the processor 202 or the multimedia device 212. The media player may also provide for filtering of stored highlights (e.g., stored occurrences) based on the tags or descriptions. Additionally, or alternatively, the media player may provide for ranking/sorting or filtering based on a ranking or by aspects or content of the stored highlights/occurrences (e.g., chronological, funny, specific player, etc.).

In some embodiments, the media player may use the identified timeline (as described herein) with the source media file to generate or create highlight clips (e.g., individual media files) based on the filtered (or non-filtered) occurrences. These highlight clips may be displayed with thumbnails on a website in a particular sequence (e.g., chronologically, based on ranking, etc.) or in a list form (or in any other format). In some embodiments, as described herein, the media player may utilize a reference or web-link to the source media file and utilize the start/end times for the occurrences in the database to identify the highlight portions and allow a user to browse between highlights by just jumping between start/end times without creating individual media highlight clips. In some embodiments, the highlights are clipped into individual media files and listed (possibly in a web interface) so that users can search and sort through the highlights and arrange them as desired (e.g., chronological, funny only, ranking, etc.)

In some embodiments, the media player may directly provide all output in a format that can be manually or automatically used in other applications (e.g., spreadsheet, JSON object, etc.). In some embodiments, individual highlight media clips do not have to be generated at that time, but all data needed to do so is provided. In some embodiments, the media player may create containers (as described herein) for review and distribution in a bounding box without need for creating and sharing individual media clips. Accordingly, the media player may not generate any actual new media clips but rather create shortcuts or identifiers of the identified occurrences with any manipulations and start/end timestamps to allow the user to “jump” between portions of the source media file without creating multiple files for storage, etc.

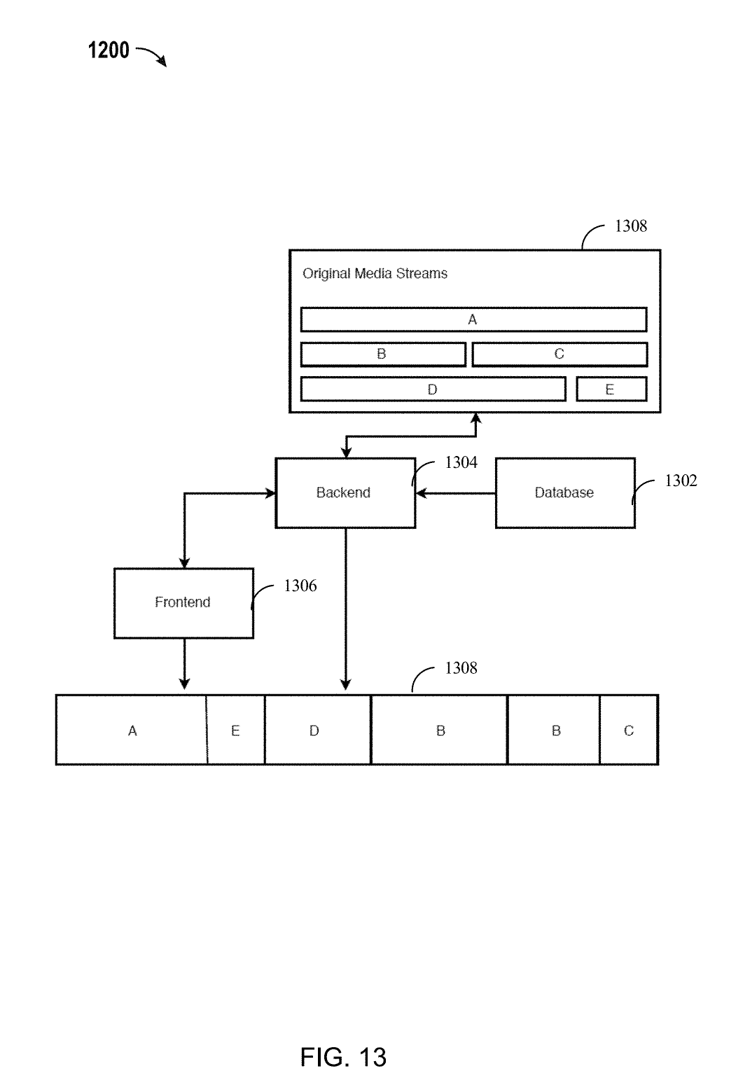

FIG. 13 is a diagram 1300 for creating a derivative work (e.g., highlight or sequence of clips) based on a plurality of input clips or media files as analyzed according to one of FIGS. 8-12, in accordance with an exemplary embodiment. As shown, the diagram 1300 includes a database 1302, a backend processor 1304, a front end processor 1306, media streams source 1308, and a derivative work 1310. In some embodiments, one or more of the components shown in FIG. 13 may comprise one of the devices of the system 100. For example, the backend processor 1304 may comprise the terminal 102, while the front end processor 1306 may comprise the computing device 106, and the media streams source 1308 may comprise the media source 104. In some embodiments, though described in relation to the layers, etc., described herein, the diagram 1300 for creating derivative works may be applied to any application of creating derivative works from one or more source media files.

In one embodiment, the backend processor 1304 may obtain a timeline for the highlights or derivative work from the database. For example, this timeline may include the start/end times for all scoring occurrences in the source media file. Thus, the timeline may include the start/end times and tags or descriptions for the identified occurrences. Based on the timeline received from the database, the backend processor 1304 may access the media streams source 1308 and obtain a specific portion of the source media files according to an identified start/end portion based on the timeline. Thus, if the timeline identifies that an occurrence exists at seconds 2-5 of source media stream D, then the backend processor 1304 may obtain the 2-5 second portion of source media stream D from the media streams source 1308. Accordingly, the backend processor 1304 may obtain all clips or portions from the media streams source 1308 as identified in the timeline. Similarly, the frontend processor 1306 may obtain any clips or portions from the media streams source 1308 via the backend processor 1304.

Once the backend processor 1304 obtains the requested clip or portion based on the timeline, the backend processor 1304 may provide or proxy the obtained portion to the frontend processor 1306. However, in providing or proxying the obtained portion, the backend processor 1304 may update metadata for the portion based on a position of the clip in the timeline. For example, if the backend processor 1304 obtained the portion from seconds 2-5 but that section corresponds to the 0-3 seconds portion of the derivative work, the backend processor 1304 may update the metadata for the clip or portion to identify it as the portion for seconds 0-3. Once the frontend processor 1306 receives the portion, the frontend processor 1306 adds it to the derivative work and waits for additional portions from the backend processor 1304.

The backend processor 1304 may repeat the steps of identifying portions of the media streams in the media streams source 1308 based on the timeline, request and obtain those portions from the media streams source 1308, adjust the metadata for the obtained portions and provide the adjusted/updated portions to the frontend processor 1306. The frontend processor 1306 appends the updated portions to the derivative work until no more portions are received from the backend processor 1304.

In some embodiments, the systems and methods as described herein may generate derivative works based on multiple media sources. When generating a derivative work including identified occurrences, the systems and methods may generate the derivative work to include multiple views or perspectives of the identified occurrences. For example, when the identified occurrence is a “kill” in a first person shooter video game, the identified occurrence and resulting derivative work (e.g., highlight clip) may include perspectives from both the person/character that was killed and the person/character that performed the kill. Similarly, perspectives from an audience or announcer, or audio from the audience or announcer may be combined with the perspectives to generate a derivative work with a combination of views, perspectives, sentiments, and reactions. Similarly, other identified occurrences that may have multiple perspectives (e.g., from characters in the game or event) and views from an audience or spectator may result in elaborate derivative works that provide all perspectives of the occurrence and all responses to the occurrence, thus providing the viewer or consumer of the derivative work with a full story and all views of each occurrence, allowing for a more encompassing and integrated experience for the viewer/consumer. In some embodiments, the frontend processor 1306 may apply manipulations or effects to the portions received from the backend processor 1304.

An apparatus or system for managing online media may perform one or more of the functions of method 300, in accordance with certain embodiments described herein. The apparatus may comprise means for receiving a media file from a media source, the media file representative of an event. In certain implementations, the means for receiving a media file can be implemented by the processor 202 or the multimedia module 212 (FIG. 2). In some implementations, the means for receiving a media file can be configured to perform the functions of block 302 (FIG. 3). The apparatus may further comprise means for receiving a user input indicating an occurrence or a type of occurrence to be identified in the media file. In certain implementations, the means for receiving a user input can be implemented by the processor 202 or I/O interfaces and devices 204. In certain implementations, the means for receiving a user input can be configured to perform the functions of block 304. The apparatus may further comprise means for obtaining data related to the media file from one or more sources, wherein the data comprises information describing or commenting on the media file or a portion thereof and wherein the data is based on the user input. In certain implementations, the means for obtaining data can be implemented by the processor 202 or I/O interfaces and devices 204. In certain implementations, the means for obtaining data can be configured to perform the functions of block 306. The apparatus may comprise means for generating a media timeline associated with the media file. In certain implementations, the means for generating can be implemented by the processor 202. In some implementations, the means for generating can be configured to perform the functions of block 308. The apparatus may further comprise means for identifying the occurrence in the media file and a timestamp for the identified occurrence based on the data, the timestamp identifying a time corresponding to a data timeline of the data. In certain implementations, the means for identifying can be implemented by the processor 202. In certain implementations, the means for identifying can be configured to perform the functions of block 310. The apparatus may further comprise means for generating an output comprising the occurrence and the timestamp in relation to the timeline. In certain implementations, the means for generating an output can be implemented by the processor 202. In certain implementations, the means for generating an output can be configured to perform the functions of block 312.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

For any discussions of video games, competitions, or football games (and similar) herein can be replaced with any one of gaming, esports events, stick and ball sports, comedy events, liveblog events, movies, news casts, concerts, contests, symposiums, presentations, conferences, and similar events. Furthermore, users and consumers may be used interchangeably to identify someone who is creating a derivative work or wishing to identify occurrences in source media files.

Any of the components or systems described herein may be controlled by operating system software, such as Windows XP, Windows Vista, Windows 7, Windows 8, Windows Server, UNIX, Linux, SunOS, Solaris, iOS, Android, Blackberry OS, or other similar operating systems. In Macintosh systems, the operating system may be any available operating system, such as MAC OS X. In other embodiments, the components or systems described herein may be controlled by a proprietary operating system. Conventional operating systems control and schedule computer processes for execution, perform memory management, provide file system, networking, I/O services, and provide a user interface, such as a graphical user interface (“GUI”), among other things.

In some embodiments, data stores and/or databases described herein may be implemented using a relational database, such as Sybase, Oracle, CodeBase and Microsoft® SQL Server as well as other types of databases such as, for example, a flat file database, an entity-relationship database, and object-oriented database, and/or a record-based database.

Computing devices, which may comprise the software and/or hardware described above, may be an end user computing device that comprises one or more processors able to execute programmatic instructions. Examples of such computing devices are a desktop computer workstation, a smart phone such as an Apple iPhone or an Android phone, a computer laptop, a tablet PC such as an iPad, Kindle, or Android tablet, a video game console, or any other device of a similar nature. In some embodiments, the computing devices may comprise a touch screen that allows a user to communicate input to the device using their finger(s) or a stylus on a display screen.

The computing devices may also comprise one or more client program applications, such as a mobile “app” (e.g. iPhone or Android app) that may be used to visualize data, and initiate the sending and receiving of messages in the computing devices. This app may be distributed (e.g. downloaded) over the network to the computing devices directly or from various third parties such as an Apple iTunes or Google Play repository or “app store.” In some embodiments, the application may comprise a set of visual interfaces that may comprise templates to display livestream or recorded events and derivative works, etc. In some embodiments, as described above, visual user interfaces may be downloaded from another server or service. This may comprise downloading web page or other HTTP/HTTPS data from a web server and rendering it through the “app”. In some embodiments, no special “app” need be downloaded and the entire interface may be transmitted from a remote Internet server to computing device, such as transmission from a web server to an iPad, and rendered within the iPad's browser.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the device 200, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, data analysis and handling and video/audio analysis may be done using any known methods. This may be done, for example, using an XMLHttpRequest (XHR) mechanism, a data push interface, Asynchronous JavaScript and XML (“Ajax”), or other communication protocols.

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the device 200 or any of the devices of the system 100. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices. Additionally, any of the methods, processes, or steps described herein may be performed in any order with any one or more of the provided steps or functions or blocks removed or including any additional steps or functions not described herein.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of managing online media, comprising:
receiving a media file from a media source, the media file representative of an event;
receiving a user input indicating an occurrence or a type of occurrence to be identified in the media file;
obtaining data related to the media file from one or more sources, wherein the data comprises information describing or commenting on the media file or a portion thereof and wherein the data is based on the user input;
generating a media timeline associated with the media file;
identifying the occurrence in the media file and a timestamp for the identified occurrence based on the data, the timestamp identifying a time corresponding to a data timeline of the data; and
generating an output comprising the occurrence and the timestamp in relation to the timeline.

2. The method of claim 1, wherein the obtained data comprises at least one comment or post from online social media discussion or comment sources, wherein the occurrence is identified based on a quantity of comments or posts received at moments during the media file, and wherein each comment or post is weighted based on at least one of a source user of the comment or post, an online source for the comment or post, and additional comments or posts generated by the comment or post.

3. The method of claim 1, wherein the obtained data comprises at least one media clip post from online social media discussion or comment sources, wherein the occurrence is identified based on a location in the media file where the media clip post is sourced from or a quantity of media clip posts indicating moments during the media file, and wherein each media clip post is weighted based on at least one of a source user of the media clip post, an online source for the media clip post, and additional comments or posts generated by the media clip post.

4. The method of claim 1, wherein the obtained data comprises at least one media generated of a spectator of the event, wherein the occurrence is identified based on an analysis of the generated media at moments during the media file, and wherein the generated media is weighted based on at least one of a source of the generated media and additional comments or posts generated by the generated media.

5. The method of claim 1, wherein the obtained data comprises data obtained from analysis of the media of the media file and wherein the occurrence is identified based on the analysis.

6. The method of claim 1, wherein the obtained data comprises source material obtained from a source of the event, including data logs, data streams, score trackers, or diagnostic data.

7. The method of claim 1, further comprising synchronizing the timestamp with the timeline.

8. The method of claim 1, further comprising identifying one or more of start/end timestamps, descriptions corresponding to the start/end timestamps, and a confidence in the identified occurrence.

9. The method of claim 8, wherein generating the output comprises storing the identified one or more of start/end timestamps, descriptions corresponding to the start/end timestamps, and a confidence in the identified occurrence in a database with the original media file and original metadata of the original media file.

10. The method of claim 1, wherein the media file relates to one or more of an esports event, a comedy event, a liveblog event, a sports event, a movie, and a contest and wherein the media file is one of a livestream or a recording that is available via a network.

11. A system for managing online media, comprising:
a memory configured to:
receive a media file from a media source, the media file representative of an event,
receive a user input indicating an occurrence or a type of occurrence to be identified in the media file, and
obtain data related to the media file from one or more sources, wherein the data comprises information describing or commenting on the media file or a portion thereof and wherein the data is based on the user input; and
a processor configured to:
generate a media timeline associated with the media file,
identify the occurrence in the media file and a timestamp for the identified occurrence based on the data, the timestamp identifying a time corresponding to a data timeline of the data, and
generate an output comprising the occurrence and the timestamp in relation to the timeline.

12. The system of claim 11, wherein the obtained data comprises at least one comment or post from online social media discussion or comment sources, wherein the occurrence is identified based on a quantity of comments or posts received at moments during the media file, and wherein each comment or post is weighted based on at least one of a source user of the comment or post, an online source for the comment or post, and additional comments or posts generated by the comment or post.

13. The system of claim 11, wherein the obtained data comprises at least one media clip post from online social media discussion or comment sources, wherein the occurrence is identified based on a location in the media file where the media clip post is sourced from or a quantity of media clip posts indicating moments during the media file, and wherein each media clip post is weighted based on at least one of a source user of the media clip post, an online source for the media clip post, and additional comments or posts generated by the media clip post.

14. The system of claim 11, wherein the obtained data comprises at least one media generated of a spectator of the event, wherein the occurrence is identified based on an analysis of the generated media at moments during the media file, and wherein the generated media is weighted based on at least one of a source of the generated media and additional comments or posts generated by the generated media.

15. The system of claim 11, wherein the obtained data comprises data obtained from analysis of the media of the media file and wherein the occurrence is identified based on the analysis.

16. The system of claim 11, wherein the obtained data comprises source material obtained from a source of the event, including data logs, data streams, score trackers, or diagnostic data.

17. The system of claim 11, wherein the processor is further configured to synchronize the timestamp with the timeline.

18. The system of claim 11, wherein the processor is further configured to identify one or more of start/end timestamps, descriptions corresponding to the start/end timestamps, and a confidence in the identified occurrence.

19. The system of claim 18, wherein generating the output comprises storing the identified one or more of start/end timestamps, descriptions corresponding to the start/end timestamps, and a confidence in the identified occurrence in a database with the original media file and original metadata of the original media file.

20. The system of claim 11, wherein the media file relates to one or more of an esports event, a comedy event, a liveblog event, a sports event, a movie, and a contest and wherein the media file is one of a livestream or a recording that is available via a network.

21. A system for managing online media, comprising:
means for receiving a media file from a media source, the media file representative of an event;
means for receiving a user input indicating an occurrence or a type of occurrence to be identified in the media file;
means for obtaining data related to the media file from one or more sources, wherein the data comprises information describing or commenting on the media file or a portion thereof and wherein the data is based on the user input;
means for generating a media timeline associated with the media file;
means for identifying the occurrence in the media file and a timestamp for the identified occurrence based on the data, the timestamp identifying a time corresponding to a data timeline of the data; and
means for generating an output comprising the occurrence and the timestamp in relation to the timeline.

22. A non-transitory, computer readable medium encoded with instructions for directing a processor to perform a method of managing online media, the method comprising:
receiving a media file from a media source, the media file representative of an event;
receiving a user input indicating an occurrence or a type of occurrence to be identified in the media file;
obtaining data related to the media file from one or more sources, wherein the data comprises information describing or commenting on the media file or a portion thereof and wherein the data is based on the user input;
generating a media timeline associated with the media file;
identifying the occurrence in the media file and a timestamp for the identified occurrence based on the data, the timestamp identifying a time corresponding to a data timeline of the data; and
generating an output comprising the occurrence and the timestamp in relation to the timeline.
